(19) United States
(12) Patent Application Publication
(10) Pub. No.: US 2026/0350060 A1
(43) Pub. Date: Nov. 5, 2026

(54) INTERACTION SYSTEM FOR ASSISTING WITH USE OF MEDIUM BY USER

(71) Applicant: NEOLAB CONVERGENCE INC., Seoul (KR)

(72) Inventors: Sang Gyu LEE, Seoul (KR); Soo Yeol KUK, Seoul (KR)

(73) Assignee: NEOLAB CONVERGENCE INC., Seoul (KR)

(21) Appl. No.: 19/712,404

(22) Filed: Jun. 18, 2026

Related U.S. Application Data
(63) Continuation of application No. PCT/KR2025/099343, filed on Feb. 7, 2025.

(30) Foreign Application Priority Data
Feb. 25, 2024 (KR) 10-2024-0026889
Dec. 11, 2024 (KR) 10-2024-0183219

(51) Int. Cl. G06F 16/3329; G06F 40/186; G10L 15/26

(52) U.S. Cl. CPC G06F 16/33295; G06F 40/186; G10L 15/26

(57) ABSTRACT

Provided is an interactive system for assisting a user to use a medium. More specifically, provided is an interactive system that, when a user reads a medium or performs a determined activity through the medium, assists the user to resolve his or her curiosity related to the details of the medium, or understand the medium, or perform the activity smoothly.

### CROSS-REFERENCE TO RELATED APPLICATIONS

This application is a continuation of International Application No. PCT/KR2025/099343 filed on Feb. 7, 2025, which claims priority to Korean Patent Application No. 10-2024-0026889 filed on Feb. 25, 2024, and Korean Patent Application No. 10-2024-0183219 filed on Dec. 11, 2024, the entire contents of which are herein incorporated by reference.

### TECHNICAL FIELD

The present disclosure relates to an interactive system for assisting a user to use a medium. More specifically, the present disclosure relates to a method and a system for performing the method in which when a user reads a medium or performs a predefined activity through the medium, the method assists the user to resolve his or her curiosity related to the details of the medium, or understand the medium, or perform the activity smoothly.

### BACKGROUND ART

Recently, sound pens have been widely used while young children (e.g., at or under the age of 7) are reading storybooks or picture books by themselves. When a child touches a book with a sound pen, the sound pen converts the text in the touched region into speech and outputs the speech.

This sound pen has the advantage of being able to read a book to children without a guardian, but there is a problem that children can only listen to the speech output from the sound pen one-sidedly, and cannot have a conversation about the details of the book as they can when the guardian reads the book to them.

The applicant developed the invention of the present disclosure considering a method that enables a child to resolve curiosity about the details of a book while reading the book, or enables the child to understand the details of the book more clearly and to become more interested in reading books.

### DISCLOSURE

### Problem to be Solved

The present disclosure is directed to, when a child reads a book alone, providing an answer to what the child says.

The present disclosure is directed to, when a child reads a book alone, leading the child to have a deeper understanding of the details of the book.

The present disclosure is directed to transferring information to a child and leading the child to learn, through a card.

Technical problems to be solved are not limited to the aforementioned technical problems and other technical problems which are not mentioned will be clearly understood by those skilled in the art from the present specification and the accompanying drawings.

### Solutions of Problems

According to one embodiment, there is provided a server for communicating with an electronic device and an AI(Artificial Intelligence) server, the server comprising: a memory, a communication unit; and a control unit configured to control the memory and the communication unit; wherein the control unit is configured to: [1] obtain reference information encoded in code data obtained by the electronic device, wherein the reference information is received via the communication unit from the electronic device or is obtained by the controller decoding the code data after receiving the code data via the communication unit from the electronic device, wherein the reference information is related to a medium that a user interacts with by using the electronic device, and wherein the reference information includes medium ID information of the medium, page information indicated by the electronic device, and position information within a page indicated by the electronic device; [2] based on the reference information, obtain from the memory interest content related to printed content in the medium and/or a part that the user is interested in among the printed content in the medium and generate medium context information; [3] obtain a speech text corresponding to a speech of the user obtained by the electronic device, wherein the speech text is obtained by converting the speech with STT(Speech-To-Text) conversion; [4] generate a prompt based on the obtained medium context information and the speech text, wherein the prompt includes the medium context information and the speech text; [5] transmit the prompt to the AI server via the communication unit; [6] receive, via the communication unit, a response of the AI server for the transmitted prompt; [7] obtain a response speech corresponding to the received response; [8] transmit the response speech to the electronic device via the communication unit.

However, the solving means of the problems are not limited to the aforementioned solving means and other solving means which are not mentioned will be clearly understood by those skilled in the art from the present specification and the accompanying drawings.

### Effects of Invention

According to an embodiment, a child can have a conversation about the details of a book with the AI model (e.g., chat GPT) while reading the book alone.

According to an embodiment, the AI model's response provided to the child may be related to the details printed in the book.

According to an embodiment, the AI model's response provided to the child may be related to a part in which the child is interested in among the details printed in the book.

According to an embodiment, the child can develop a greater understanding of or interest in the contents of the book than can be obtained by simply reading the book.

According to an embodiment, the child can experience various activities through cards.

The effects of the present disclosure are not limited to the aforementioned effects and other effects which are not mentioned will be clearly understood by those skilled in the art from the present specification and the accompanying drawings.

### BRIEF DESCRIPTION OF THE DRAWINGS

FIG. 1 is a diagram illustrating an interactive system according to an embodiment.

FIG. 2 is a diagram illustrating a configuration of an electronic device according to an embodiment.

FIGS. 3A and 3B are diagrams illustrating a code printed on a medium according to an embodiment.

FIG. 4 is a diagram illustrating a configuration of a main server according to an embodiment.

FIG. 5 is a diagram illustrating a configuration of an AI server according to an embodiment.

FIG. 6 is a block diagram illustrating an electronic pen service system using a conversational AI service according to an embodiment.

FIG. 7 is a block diagram illustrating an electronic pen service system using a conversational AI service according to another embodiment.

FIG. 8 is a diagram illustrating pieces of information stored in a database according to an embodiment.

FIG. 9 is a diagram illustrating an aspect in which regions are distinguished in a medium, according to an embodiment.

FIG. 10 is a diagram illustrating an aspect in which regions are distinguished in a medium, according to another embodiment.

FIG. 11 is a flowchart illustrating a method of assisting a user to use a medium by using artificial context information according to a first embodiment.

FIG. 12 is a flowchart illustrating a method of assisting a user to use a medium by using artificial context information according to a second embodiment.

FIG. 13 is a flowchart illustrating a method of assisting a user to use a medium by using artificial context information according to a third embodiment.

FIG. 14 is a flowchart illustrating a method of assisting a user to use a medium by using artificial context information according to a fourth embodiment.

FIG. 15 is a flowchart illustrating a method of assisting a user to use a medium by using artificial context information, according to a fifth embodiment.

FIG. 16 is a diagram illustrating a process of obtaining artificial context information, according to the fifth embodiment.

FIG. 17 is a diagram illustrating a prompt generated using artificial context information, according to the fifth embodiment.

FIG. 18 is a flowchart illustrating a method of generating a subsequent prompt, according to the fifth embodiment.

FIG. 19 is a diagram illustrating a subsequent prompt generated using artificial context information, according to the fifth embodiment.

FIG. 20 is a diagram illustrating a process of obtaining a pre-stored prompt, according to a sixth embodiment.

FIG. 21 is a diagram illustrating a pre-stored prompt, according to the sixth embodiment.

FIG. 22 is a diagram illustrating a subsequent prompt generated using artificial context information, according to the sixth embodiment.

FIG. 23 is a flowchart illustrating a method of assisting a user to use a medium by using medium context information, according to a seventh embodiment.

FIG. 24 is a diagram illustrating a process of obtaining medium context information, according to the seventh embodiment.

FIG. 25 is a diagram illustrating a prompt generated using medium context information, according to the seventh embodiment.

FIG. 26 is a flowchart illustrating a method of generating a subsequent prompt, according to the seventh embodiment.

FIG. 27 is a flowchart illustrating a method of assisting a user to use a medium by using artificial context information and medium context information, according to an eighth embodiment.

FIG. 28 is a diagram illustrating a process of obtaining artificial context information and medium context information, according to the eighth embodiment.

FIG. 29 is a diagram illustrating a prompt generated by using artificial context information and medium context information, according to the eighth embodiment.

FIG. 30 is a flowchart illustrating a method of assisting a user to use a medium by using context information according to a ninth embodiment.

### DETAILED DESCRIPTION OF THE INVENTION

According to one embodiment, there is provided a server for communicating with an electronic device and an AI(Artificial Intelligence) server, the server comprising: a memory; a communication unit; and a control unit configured to control the memory and the communication unit; wherein the control unit is configured to: [1] obtain reference information encoded in code data obtained by the electronic device, wherein the reference information is received via the communication unit from the electronic device or is obtained by the controller decoding the code data after receiving the code data via the communication unit from the electronic device, wherein the reference information is related to a medium that a user interacts with by using the electronic device, and wherein the reference information includes medium ID information of the medium, page information indicated by the electronic device, and position information within a page indicated by the electronic device; [2] based on the reference information, obtain from the memory interest content related to printed content in the medium and/or a part that the user is interested in among the printed content in the medium and generate medium context information; [3] obtain a speech text corresponding to a speech of the user obtained by the electronic device, wherein the speech text is obtained by converting the speech with STT(Speech-To-Text) conversion; [4] generate a prompt based on the obtained medium context information and the speech text, wherein the prompt includes the medium context information and the speech text; [5] transmit the prompt to the AI server via the communication unit; [6] receive, via the communication unit, a response of the AI server for the transmitted prompt; [7] obtain a response speech corresponding to the received response; [8] transmit the response speech to the electronic device via the communication unit.

The memory stores a plurality of medium texts and each of the medium texts corresponds to at least part of a particular medium, and the control unit loads a medium text corresponding to the medium ID information of the reference information among the plurality of medium texts from the memory and obtains the medium text as the medium context information.

The memory stores a plurality of page-specific texts and each of the page-specific texts corresponds to at least part of texts printed on a particular page of a particular medium, and the control unit loads a page-specific text corresponding to the medium ID information and the page information of the reference information among the plurality of page-specific texts from the memory and obtains the page-specific text as the medium context information.

The memory stores a plurality of position-specific texts and each of the position-specific texts corresponds to at least part of texts printed on a particular position in a particular page of a particular medium, and the control unit loads a position-specific text corresponding to the medium ID information, the page information, and the position information of the reference information among the plurality of position-specific texts from the memory and obtains the position-specific text as the medium context information.

The prompt is generated by concatenating the speech text to the medium context information.

The prompt further includes an explanatory text for the medium context information.

The prompt further includes pre-stored user information, and the user information includes at least one of an age and sex for the user.

The prompt further includes a pre-stored guide text, and the guide text includes a consideration for the AI server when generating the response.

The control unit: obtains a prompt template, and modifies the prompt template using the medium context information and the speech text to generate the prompt.

The prompt includes at least part of a past prompt transmitted to the AI server before the code data is obtained from the electronic device.

The control unit transmits the past prompt to the AI server via the communication unit and receives a past response for the past prompt from the AI server, and the prompt includes at least part of the past response.

The reference information further includes region identification information related to a question or an instruction printed in the medium with which the user is interacting using the electronic device, and the region identification information identifies a preset region in the medium, the control unit, based on the reference information, obtains artificial context information corresponding to the question or the instruction printed on the preset region from the memory, and the prompt further includes the artificial context information.

The control unit: obtains a subsequent speech text corresponding to a subsequent speech of the user obtained by the electronic device, wherein the subsequent speech is obtained by converting the subsequent speech with STT conversion, generates a subsequent prompt based on the subsequent speech text, transmits the subsequent prompt to the AI server via the communication unit, receives a subsequent response of the AI server the transmitted subsequent prompt via the communication unit, obtains a subsequent response speech corresponding to the subsequent response, and transmits the subsequent response speech to the electronic device via the communication unit.

The subsequent prompt further includes the medium context information.

The AI server comprises LLM(Large Language Model).

The electronic device: comprises an image sensor, and is configured to capture a region of the medium by the user's manipulation and obtain the code data from a captured image The electronic device has a pen-shape with one end and other end, and in response to the user indicating a region of the medium with the one end of the electronic device, the electronic device is configured to capture the medium by using the image sensor arranged at the one end.

According to other embodiment, there is provided a server for communicating with an electronic device and an AI(Artificial Intelligence) server, the server comprising: a memory; a communication unit; and a control unit configured to control the memory and the communication unit; wherein the control unit is configured to: [1] obtain reference information encoded in code data obtained by the electronic device, wherein the reference information is received via the communication unit from the electronic device or is obtained by the controller decoding the code data after receiving the code data via the communication unit from the electronic device, wherein the reference information is related to a medium that a user interacts with by using the electronic device, and wherein the reference information includes medium ID information of the medium, page information indicated by the electronic device, and position information within a page indicated by the electronic device; [2] based on the reference information, obtain from the memory interest content related to printed content in the medium and/or a part that the user is interested in among the printed content in the medium and generate medium context information; [3] obtain speech data corresponding to a speech of the user obtained by the electronic device, [4] generate a prompt based on the obtained medium context information and the speech data, [5] transmit the prompt to the AI server via the communication unit; [6] receive, via the communication unit, a response of the AI server for the transmitted prompt; [7] transmit the received response or a response speech corresponding to the response to the electronic device via the communication unit.

A data type of the medium context information is any one of text, sound, image or video.

When a data type of the medium context information is text and a data type supported by the AI server is sound, the control unit convert the medium context information such that the data type of the medium context information becomes sound, before generating the prompt.

According to other embodiment, there is provided a server for communicating with an electronic device and an AI(Artificial Intelligence) server, the server comprising: a memory; a communication unit; and a control unit configured to control the memory and the communication unit; wherein the control unit is configured to: [1] obtain reference information encoded in code data obtained by the electronic device, wherein the reference information is received via the communication unit from the electronic device or is obtained by the controller decoding the code data after receiving the code data via the communication unit from the electronic device, and wherein the reference information includes region identification information for identifying a predetermined region in a medium which the user interacts with by using the electronic device, and at least one of a symbol, a question, and an instruction is printed on the predetermined region; [2] based on the reference information, obtain from the memory pre-stored artificial context information corresponding to the predetermined region; [3] obtain a speech text corresponding to a speech of the user obtained by the electronic device, wherein the speech text is obtained by converting the speech with STT(Speech-To-Text) conversion; [4] generate a prompt based on the obtained artificial context information and the speech text, wherein the prompt includes the artificial context information and the speech text; [5] transmit the prompt to the AI server via the communication unit; [6] receive a response of the AI server for the transmitted prompt from the server; [7] obtain a response speech corresponding to the received response; [8] transmit the response speech to the electronic device via the communication unit.

The memory stores a plurality of questions and each of the questions corresponds to a question printed on a particular medium, and the artificial context information is a question corresponding to the region identification information of the reference information among the plurality of questions.

The memory stores a plurality of instructions and each of the instructions corresponds to an instruction printed on a particular medium, and the artificial context information is an instruction corresponding to the region identification information of the reference information among the plurality of instructions.

The reference information further includes a medium ID, and the artificial context information is information corresponding to the medium ID and the region identification information among information stored in the memory.

The reference information further includes page information, and the artificial context information is information corresponding to the medium ID, the page information, and the region identification information among information stored in the memory.

The prompt is generated by concatenating the speech text to the artificial context information.

The prompt further includes an explanatory text for the artificial context information.

The prompt further includes pre-stored user information, and the user information includes at least one of an age and sex for the user.

The prompt further includes a pre-stored guide text, and the guide text includes a consideration for the AI server when generating the response.

The control unit obtains a prompt template and modifies the prompt template using the artificial context information and the speech text to generate the prompt.

The prompt includes at least part of a past prompt transmitted to the AI server before the code data is obtained from the electronic device.

The control unit transmits the past prompt to the AI server via the communication unit and receives a past response for the past prompt from the AI server, and the prompt includes at least part of the past response.

The reference information includes medium ID information of the medium, page information indicated by the electronic device, and position information within a page indicated by the electronic device, the control unit, based on the reference information, obtains from the memory interest content related to printed content in the medium and/or a part that the user is interested in among the printed content in the medium and generates medium context information, and the prompt further includes the medium context information.

The control unit: obtains a subsequent speech text corresponding to a subsequent speech of the user obtained by the electronic device, wherein the subsequent speech is obtained by converting the subsequent speech with STT conversion, generates a subsequent prompt based on the subsequent speech text and the artificial context information, transmits the subsequent prompt to the AI server via the communication unit, receives a subsequent response of the AI server the transmitted subsequent prompt via the communication unit, obtains a subsequent response speech corresponding to the subsequent response, and transmits the subsequent response speech to the electronic device via the communication unit.

The subsequent prompt further includes the medium context information.

The AI server comprises LLM(Large Language Model).

The electronic device: comprises an image sensor, and is configured to capture a region of the medium by the user's manipulation and obtain the code data from a captured image.

The electronic device has a pen-shape with one end and other end, and in response to the user indicating a region of the medium with the one end of the electronic device, the electronic device is configured to capture the medium by using the image sensor arranged at the one end.

According to other embodiment, there is provided a server for communicating with an electronic device and an AI(Artificial Intelligence) server, the server comprising: a memory; a communication unit; and a control unit configured to control the memory and the communication unit; wherein the control unit is configured to: [1] obtain reference information encoded in code data obtained by the electronic device, wherein the reference information is received via the communication unit from the electronic device or is obtained by the controller decoding the code data after receiving the code data via the communication unit from the electronic device, and wherein the reference information is related to a question or an instruction printed in a medium which the user interacts with by using the electronic device, and wherein the reference information includes region identification information for identifying a predetermined region in the medium, [2] based on the reference information, obtain from the memory pre-stored artificial context information corresponding to the predetermined region; [3] generate a prompt based on the obtained artificial context information, wherein the prompt includes the artificial context information; [4] transmit the prompt to the AI server via the communication unit; [5] receive a response of the AI server for the transmitted prompt from the server, [6] obtain a response speech corresponding to the received response; [7] transmit the response speech to the electronic device via the communication unit.

The control unit: obtains a speech text corresponding to a speech of the user obtained by the electronic device, wherein the speech of the user is obtained after the response speech is transmitted to the electronic device and outputted, and the speech text is obtained by converting the subsequent speech with STT(Speech-To-Text) conversion, generates a subsequent prompt based on the speech text and transmits the subsequent prompt to the AI server via the communication unit, obtains a subsequent response of the AI server in response to the transmitted subsequent prompt via the communication unit, obtains a subsequent response speech corresponding to the received subsequent response, and transmits the subsequent response speech to the electronic device via the communication unit.

According to other embodiment, there is provided a server for communicating with an electronic device and an AI(Artificial Intelligence) server, the server comprising: a memory; a communication unit; and a control unit configured to control the memory and the communication unit; wherein the control unit is configured to: [1] obtain reference information encoded in code data obtained by the electronic device, wherein the reference information is received via the communication unit from the electronic device or is obtained by the controller decoding the code data after receiving the code data via the communication unit from the electronic device, and wherein the reference information includes region identification information for identifying a predetermined region in a medium which the user interacts with by using the electronic device, and at least one of a symbol, a question, and an instruction is printed on the predetermined region; [2] based on the reference information, obtain from the memory pre-stored artificial context information corresponding to the predetermined region; [3] obtain speech data corresponding to a speech of the user obtained by the electronic device, [4] generate a prompt based on the obtained artificial context information and the speech data, [5] transmit the prompt to the AI server via the communication unit;

receive a response of the AI server for the transmitted prompt from the server; [7] transmit the received response or a response speech corresponding to the received response to the electronic device via the communication unit.

A data type of the artificial context information is any one of text, sound, image or video.

When a data type of the artificial context information is text and a data type supported by the AI server is sound, the control unit convert the artificial context information such that the data type of the artificial context information becomes sound, before generating the prompt.

The above-described objectives, features, and advantages of the present disclosure will be more apparent from the following detailed description with reference to the accompanying drawings. However, various modifications may be made to the present disclosure and various embodiments of the present disclosure may be practiced. Therefore, specific embodiments are illustrated in the accompanying drawings and will be described in detail below.

In the drawings, the thicknesses of layers and regions are exaggerated for clarity. In addition, when an element or layer is referred to as being on another element or layer, it may be directly on the other element or layer or an intervening layer or element may be present. Throughout the specification, the same reference numerals denote the same elements in principle. In addition, elements having the same function within the same scope illustrated in the drawings of the embodiments are described using the same reference numerals, and a redundant description will be omitted.

Numbers (for example, first, second, etc.) used in the description of the present specification are merely identifiers for distinguishing one element from another.

In addition, the terms “module” and “part” that are used to name an element in the description below are used considering only the ease with which the present specification is written. The terms are not intended as having different special meanings or functions and thus may be used individually or interchangeably.

In the following embodiments, an expression used in the singular encompasses the expression of the plural, unless it has a clearly different meaning in the context.

In the following embodiments, it is to be understood that terms such as “including” or “having” are intended to indicate the existence of features or elements disclosed in the specification, and are not intended to preclude the possibility that one or more other features or elements may be added.

Sizes of elements in the drawings may be exaggerated or reduced for convenience of description. For example, any size and thickness of each element shown in the drawings are shown for convenience of description, and the present disclosure is not limited thereto.

In a case in which a particular embodiment is realized otherwise, a particular process may be performed out of the order described. For example, two processes described in succession may be performed substantially simultaneously, or may be performed in an order opposite to the order described.

In the following embodiments, when films, regions, or elements are referred to as being connected to each other, the films, regions, or elements are directly connected to each other or the films, regions, or elements are indirectly connected to each other with intervening films, regions, or elements therebetween.

For example, in the present specification, when films, regions, or elements are referred to as being electrically connected to each other, the films, regions, or elements are directly electrically connected to each other or the films, regions, or elements are indirectly electrically connected to each other with intervening films, regions, or elements therebetween.

Unless otherwise specifically stated or apparent from the context, the term “about” with respect to a numerical value may be understood to mean the mentioned numerical value and up to +/−10% of the numerical value, and the term “about” with respect to a numerical value range may be understood to mean a range from a numerical value 10% lower than the lower limit value of the numerical value range to a numerical value 10% higher than the upper limit value of the numerical value range.

### 1. Summary

As described in the background technology of the invention, the use of an AI server may be considered as a solution to the problem that a sound pen only reads books, but cannot have a conversation with a child or answer the child's questions. That is, a system that records the child's speech and inputs the recorded speech (or text resulting from conversion of the speech) to a large language model (LLM), such as ChatGPT (generative pre-trained transformer), to generate a response and outputs the response to the child may be considered.

Herein, the child's young age and relatively low language skills make it difficult for him or for her to form definite sentences, and to compensate for the lack of language skills, the child frequently uses demonstrative pronouns such as “this” or “that” with his or her finger while reading. This characteristic should be taken into account.

That is, the large language model can only receive the child's speech (or text resulting from conversion of the speech) as an input, and cannot receive information such as the child is pointing with his or her finger, as an input, so it is difficult to know exactly what the child is trying to say or what the child is wondering.

For example, when the child is reading the Snow White storybook and asks a question, such as “Is this where the princess lives?”, or “Why is the character bullying the princess?”, and the question is transferred to the large language model without any context (or without any context about the Snow White story), the large language model may have difficulty in understanding the child's intent, thus outputting a response less relevant to the Snow White storybook.

To address these issues, the present disclosure proposes a method in which when the user's speech (for example, the user's question) is input, the details of content related to the user's speech are extracted and used.

In this case, in order to specify a content related to the user's speech, a code identifiable by a camera is printed on the medium together with the content, and a code recognized by the electronic device used by the user is used.

Thus, according to the method provided by the present disclosure, when the user simply has a conversation with a generative and conversational AI model, such as GPT, the user's speech as well as information on a content printed on the medium that the user is interested in could become more available. Using the content printed on the medium that the user is interested in when a conversation with the AI model takes place helps form the basic “context” for the AI model to converse with the user. That is, further generating information on a “context” in the conversation between the user and the AI model and using this context information in the conversation is a key concept of the method provided by the present disclosure to solve the problems in the art.

Hereinafter, specific systems for realizing methods provided by the present disclosure will be described. Further, various embodiments of the methods provided by the present disclosure will be described. In particular, specific methods of how to generate context information and how to transfer the context information to an AI model will be clearly understood from the description below.

### 2. Interactive System

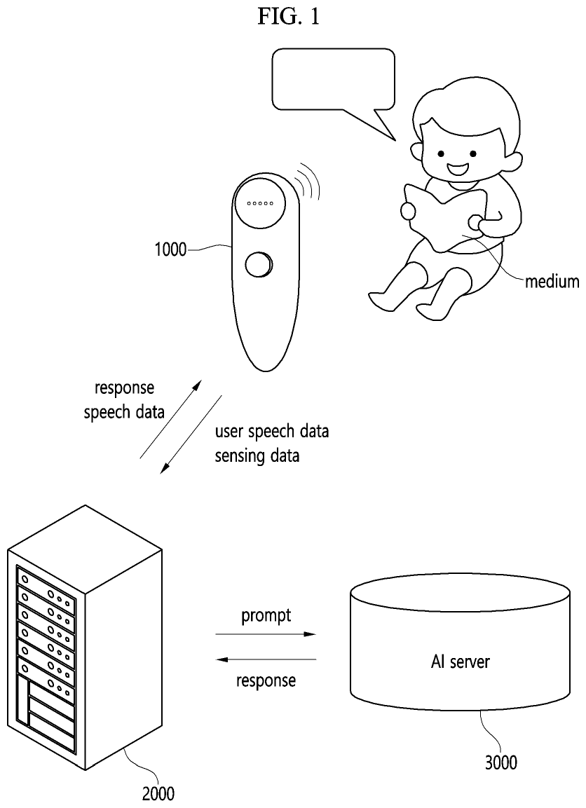

Hereinafter, the configuration and operation of an interactive system will be described with reference to FIG. 1.

FIG. 1 is a diagram illustrating an interactive system 10 according to an embodiment.

Referring to FIG. 1, the interactive system 100 may include an electronic device 1000, a main server 2000, and an AI server 3000.

In using a medium, a user may use the interactive system 100 to interact with the medium.

Herein, the medium means a physical medium on which information or contents are recorded. For example, the information or contents recorded on the medium may be a story, explanation, information, question, activity, or instruction. In addition, the physical medium may be a book, paper, or film, as well as a partial region of a surface of an object, a partial region of a surface of a sculpture, a partial region of a surface of a piece of furniture, a partial region of a surface of an electronic product, or a partial region of a surface of a building. Herein, the way information is recorded on the medium does not mean an “electronic” method, but rather that a user recognizes the information recorded on the medium through sight. For example, information or contents, such as an image or text, may be printed on the medium. In the meantime, the medium may be a panel, such as an LCD, OLED, or LED, or a display including a panel, and information or contents, such as an image or text, may be electronically output on the medium.

Using the medium by the user may be, for example, reading a story or information recorded on the medium by the user, performing an activity or instruction recorded on the medium by the user.

The user may use the interactive system 100 to interact with the medium.

As a representative example, interacting means conversing with the interactive system 100 about the medium. Specifically, while using the medium, the user may ask questions and receive answers via the electronic device 1000. For example, interaction may be performed in such a manner that while reading a book, the user asks questions or expresses opinions through voice and the electronic device 1000 outputs answers to the questions or responses to the opinions in speech. For another example, interaction may be performed in such a manner that the electronic device 1000 outputs an activity or instruction printed on a card in speech and the user performs the activity or responds to the instruction.

The process in which the user uses the electronic device 1000 to interact with the medium may be performed as follows.

First, the electronic device 1000 may obtain image data for the medium. The image data means an image obtained by the electronic device 1000 capturing a part of the medium by the user's manipulation. For example, while the user positions the electronic device 1000 in contact with or near the part of the medium, the electronic device 1000 may capture the part of the medium to obtain the image data. Information on the medium may be encoded in the image data. The electronic device 1000 may transmit the image data to the main server 2000.

The electronic device 1000 may obtain speech data of the user. The electronic device 1000 may obtain user speech data by recording the user's speech. The electronic device 1000 may transmit the user speech data to the main server 2000.

The electronic device 1000 may transmit an electronic device ID to the main server 2000. The electronic device ID is information for identifying the electronic device 1000, and may be used to generate session information, which will be described later.

The main server 2000 may use the image data and the speech data to generate a prompt. Specifically, the main server 2000 may analyze the image data to obtain context information, and may use the context information and the speech data to generate a prompt.

The main server 2000 may transmit the prompt to the AI server 3000. The AI server 3000 may include a large language model (LLM) and receive the prompt to output a response. The AI server 3000 may transmit the response to the main server 2000, and the main server may generate response speech data for the response and transmit the response speech data to the electronic device 1000. The electronic device 1000 may output the received response speech data.

When the user interacts with the medium by using the interactive system 100, the above-described context information may be used to specify the context of interaction. For example, when the user expresses questions or opinions while reading (or pointing at) part of a book, the details of the book or the details of the part of the book may be the context of interaction. Herein, information on the part read (or the part pointed out) by the user while expressing the questions or opinions may be obtained as context information, and the obtained context information may be used to generate a prompt. In this case, a response generated by the AI server 3000 may also consider the context information, and response speech data output via the electronic device 1000 includes the details corresponding to the intent of the user's question or expressed opinion.

The context information may include medium context information or artificial context information or both.

The medium context information means information forming the context that the medium contains, among pieces of information on the medium. For example, when the medium is a book on which a particular story is printed, the context of the medium may mean the particular story and the medium context information is information on part of the particular story and may mean a word, sentence, paragraph, or image constituting the particular story. The medium context information may be information on the part the user interacts with among pieces of information on the medium. For example, the medium context information may be information on a word, sentence, paragraph, or image of part pointed out or touched using the electronic device 1000 by the user in the context of the medium. A method of obtaining the medium context information will be described later.

The artificial context information means information not forming the context that the medium contains, among pieces of information on the medium. For example, the artificial context information may include information on an instruction, question, or activity among pieces of information on the medium. More specifically, when the medium is a book on which a particular story is printed, the context of the medium may mean the particular story and the medium context information may mean a question about the particular story, an instruction, or a sentence leading to a particular behavior.

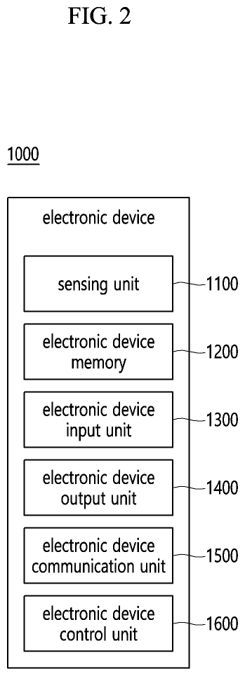

Hereinafter, each element of the interactive system 100 will be described in detail with reference to FIGS. 2 to 5.

FIG. 2 is a diagram illustrating a configuration of an electronic device 1000 according to an embodiment.

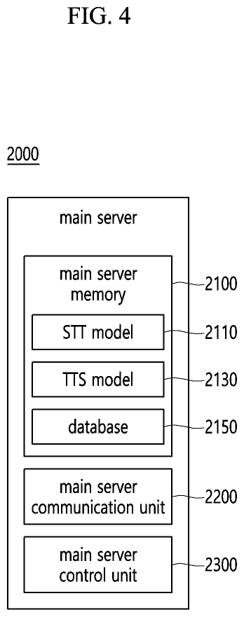

FIG. 4 is a diagram illustrating a configuration of the main server 2000 according to an embodiment.

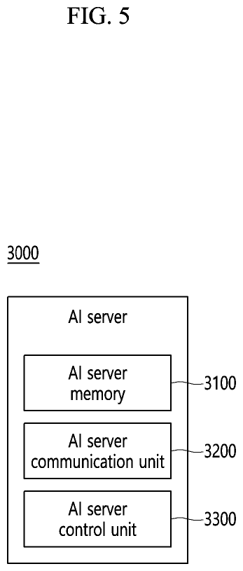

FIG. 5 is a diagram illustrating a configuration of the AI server 3000 according to an embodiment.

Referring to FIG. 2, the electronic device 1000 may include a sensing unit 1100, an electronic device memory 1200, an electronic device input unit 1300, an electronic device output unit 1400, an electronic device communication unit 1500, and an electronic device control unit 1600.

The electronic device 1000 may capture the details printed on the medium through the sensing unit 1100. For example, the sensing unit 1100 may include an image sensor, such as a camera, and according to the user's manipulation, the electronic device 1000 may capture at least a partial region of the medium to obtain an image.

The image obtained through the sensing unit 1100 may include a code. Specifically, a code may be printed on the medium according to a preset rule, and an image obtained by capturing the medium may include a code. Herein, the ink used to print the code on the medium may be different from the ink used to print the content on the medium. For example, the code may be printed on the medium using an ink that absorbs infrared light, and the sensing unit 1100 of the electronic device 1000 may include an infrared image sensor, and an image captured by the sensing unit 1100 may include a code printed on the medium rather than a content printed thereon (or may include both a content and a code).

As will be described later, the electronic device 1000 may capture the medium on which a code is printed to obtain a code image, and the electronic device 1000 or the main server 2000 may analyze the obtained code image to obtain reference information indicating information on the medium or information on the medium.

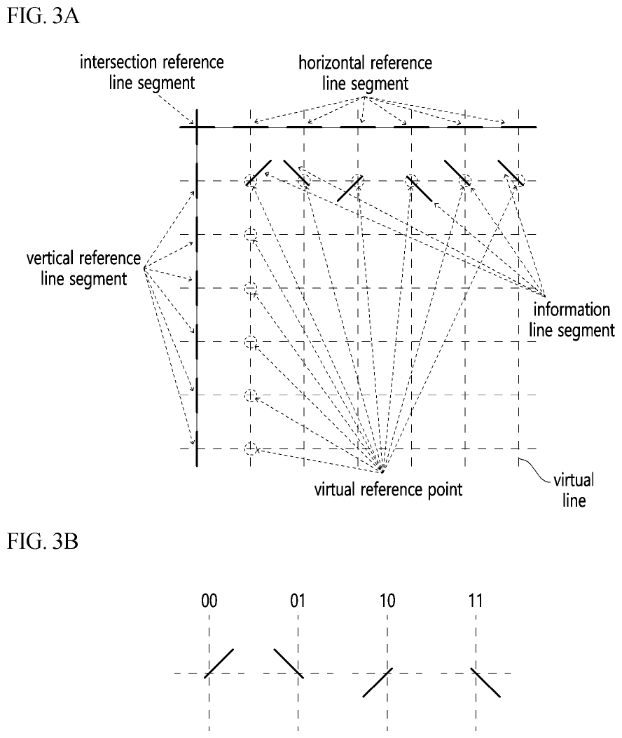

Hereinafter, the code printed on the medium will be described in detail with reference FIGS. 3A and 3B.

FIGS. 3A and 3B are diagrams illustrating a code printed on a medium according to an embodiment. FIG. 3A is a diagram illustrating a unit cell constituting a code. FIG. 3B is a diagram illustrating a method of encoding information in information line segments.

Referring to FIGS. 3A and 3B, a code may be realized in such a manner that one unit cell is repeatedly printed in two dimensions to the size of the medium. Each unit cell includes a plurality of line segments (or pints) placed according to a particular rule, and the particular rule may be determined according to information encoded in that unit cell.

Referring to FIG. 3A, line segments included in a unit cell are divided into reference line segments and information line segments, and the reference line segments include a horizontal reference line segment, a vertical reference line segment, and an intersection reference line segment.

When the electronic device 1000 or the main server 2000 analyzes a code image, regions of unit cells are divided through the reference line segments and information encoded in the unit cells may be obtained through the information line segments.

In the meantime, within a unit cell, virtual lines may be defined, and the virtual lines include a plurality of horizontal virtual lines extending in a horizontal direction and a plurality of vertical virtual lines extending in a vertical direction. The virtual lines usually, but not necessarily, mean lines that are not printed on the medium. The virtual lines may be printed on the medium.

A plurality of horizontal virtual lines and a plurality of vertical virtual lines meet to form a plurality of intersection points, and the plurality of intersection points are hereafter referred to as virtual reference points. The virtual reference points are also usually, but not necessarily, not printed on the medium. The virtual reference points may be printed on the medium.

Referring to FIGS. 3A and 3B, it is shown that one unit cell includes a total of seven horizontal virtual lines and a total of seven vertical virtual lines. It is shown that on the topmost horizontal virtual line, horizontal reference line segments are placed, and on the leftmost vertical virtual line, the vertical reference line segments are placed.

According to a method of placing the information line segments, a particular number of binary numbers may be expressed. Hereinafter, for convenience of description, the case in which information that information line segments may express represents four binary numbers (i.e., 2 bits) will be described.

For clarity, rectangular coordinate systems using the above-described virtual reference points as origin points and defined in directions of horizontal reference line segments and vertical reference line segments are assumed.

When information to be encoded through an information line segment is “00”, the information line segment may be placed (see the leftmost part in FIG. 3B) in such a manner that one end (the end positioned closer to the virtual reference point) of the information line segment is positioned in the third quadrant of the rectangular coordinate system and the other end (the end positioned farther away from the virtual reference point) is positioned in the first quadrant of the rectangular coordinate system.

When information to be encoded through an information line segment is “01”, the information line segment may be placed (see the second part in FIG. 3B from the left) in such a manner that one end (the end positioned closer to the virtual reference point) of the information line segment is positioned in the fourth quadrant of the rectangular coordinate system and the other end (the end positioned farther away from the virtual reference point) is positioned in the second quadrant of the rectangular coordinate system.

In addition, when information to be encoded through an information line segment is “10”, the information line segment may be placed (see the third part in FIG. 3B from the left) in such a manner that one end (the end positioned closer to the virtual reference point) of the information line segment is positioned in the first quadrant of the rectangular coordinate system and the other end (the end positioned farther away from the virtual reference point) is positioned in the third quadrant of the rectangular coordinate system.

In addition, when information to be encoded through an information line segment is “11”, the information line segment may be placed (see the fourth part in FIG. 3B from the left) in such a manner that one end (the end positioned closer to the virtual reference point) of the information line segment is positioned in the second quadrant of the rectangular coordinate system and the other end (the end positioned farther away from the virtual reference point) is positioned in the fourth quadrant of the rectangular coordinate system.

When 2-bit information is encoded in an information line segment as shown in FIG. 3B and one unit cell includes 36 information line segments as shown in FIG. 3A, information that may be encoded in one unit cell is 2bits*36 -72 bits.

However, the way of placing an information line segment is to position one end and the other end of the information line segment, so this way may be designed by the angle at which the information line segment is tilted or by a method of spacing the information line segment from the reference point. In this case, information that may be encoded in an information line segment is not limited to 2 bits, and may be 3 bits or more.

In the meantime, a code may be realized in various methods in addition to the above-described method. For example, a code may have the form of an image in which particular information is encoded, such as a QR code.

The sensing unit 1100 obtains an image (hereinafter, a code image) of part of a plurality of codes pre-printed on the medium. The electronic device 1000 analyzes the obtained code image to obtain information encoded in the code image.

According to some embodiments, pieces of information, such as the title of the medium, a page of the medium, and the X coordinate and the Y coordinate within one page of the medium, may be encoded in the codes pre-printed on the medium. For example, (a book title, a page, X coordinate, and Y coordinate) may be encoded in one unit of codes. In this case, when the user indicates a particular position on the medium through the electronic device 1000, the electronic device 1000 be aware of the particular position on the medium indicated by the user.

According to some other embodiments, pre-determined region identification information may be encoded in codes pre-printed on the medium. In this case, the user may be aware of the type of content (e.g., text, an illustration, or an icon) printed in a particular region of the medium through the electronic device 1000.

According to some embodiments, the electronic device 1000 may transmit pieces of information (hereinafter, code data) obtained through analysis of a code image to the main server 2000, and the main server 2000 may use the received code data to specify what the text or image (that is, the part of the printed content) printed in a particular position on the medium indicated by the user is.

According to some other embodiments, the electronic device 1000 may transmit the obtained code image to the main server 2000. In this case, the main server 2000 may analyze the code image to obtain the above-described code data. As described above, what the text or image (that is, part of the printed content) printed in a particular position on the medium indicated by the user is may be specified.

Referring back to FIG. 2, the electronic device memory 1200 may store information processed by the electronic device 1000, and a program executed by the electronic device 1000. For example, the electronic device memory 1200 may store image data obtained by the sensing unit 1100. For another example, the electronic device memory 1200 may store code data obtained by analyzing image data. For still another example, the electronic device memory 1200 may store data about the medium obtained using code data.

The electronic device memory 1200 may be realized in the form of various storage devices, such as a ROM, a RAM, an EPROM, a flash drive, or a hard drive, in terms of hardware.

The electronic device input unit 1300 may include a microphone. The electronic device input unit 1300 may record the user's speech to generate a speech signal. The speech signal may be stored as speech data in the electronic device memory 1200.

The electronic device input unit 1300 may include a trigger button. When the user manipulates (e.g., presses or touches) the trigger button, the microphone included in the electronic device input unit 1300 is activated to start speech recording. The user may press the trigger button and ask questions or say what he or she wishes to say, and the electronic device input unit 1300 may record the user's speech to generate a speech signal.

The electronic device input unit 1300 may be a keyboard, button, mouse, microphone, camera, sensor, touch screen, or any combination thereof, but is not limited thereto.

The electronic device output unit 1400 may include a speaker. The electronic device output unit 1400 may output response speech data obtained from the main server 2000.

The electronic device output unit 1400 may be a display, speaker, indicator, or any combination thereof, but is not limited thereto.

The electronic device communication unit 1500 may perform data communication between the electronic device 1000 and an external device. For example, the electronic device communication unit 1500 may transmit a code image (or code data or context information) to the main server 2000. For another example, the electronic device communication unit 1500 may receive response speech data from the main server 2000.

The electronic device communication unit 1500 may be, for example, a wired/wireless local area network (LAN) module, a WAN module, an Ethernet module, a Bluetooth module, a Zigbee module, a Universal Serial Bus (USB) module, an IEEE 1394 module, a Wi-Fi module, a mobile communication module, a satellite communication module or any combination thereof, but is not limited thereto.

The electronic device control unit 1600 may control the elements of the electronic device 1000 or execute a program stored in the electronic device memory 1200.

The electronic device control unit 1600 may be, for example, a central processing unit (CPU), a graphics processing unit (GPU), a neural processing unit (NPU), a digital signal processor (DSP), a state machine, an application specific integrated circuit (ASIC), a radio-frequency integrated circuit (RFIC) or any combination thereof, but is not limited thereto.

Hereinafter, for convenience of description, it will be described that the electronic device 1000 is a device having the shape of a pen, and when the user positions an end of the electronic device 1000 in contact with or near the medium on which a code is printed, the sensing unit 1100 captures the medium to obtain a code image and the electronic device 1000 analyzes the code image to obtain code data and the electronic device 1000 transmits the code data to the main server 2000. However, the technical idea of the present disclosure is not limited thereto. For example, the electronic device 1000 may be a smartphone or tablet PC. Herein, an application for performing the functions (e.g., capturing a code image, obtaining code data, analysis, and transmission) of the above-described electronic device 1000 may be stored in the smartphone or tablet PC.

The main server 2000 may include a main server memory 2100, a main server communication unit 2200, and a main server control unit 2300.

The main server memory 2100 may store information processed by the main server 2000, and a program executed by the main server 2000. Referring to FIG. 4, the main server memory 2100 may store at least a speech-to-text (STT) model 2110, a text-to-speech (TTS) model 2130, and a database 2150.

The STT model 2110 means a program that converts speech data (or a speech signal) to text data (or speech text). The main server 2000 may use the STT model to convert speech data of the user received from the electronic device 1000 to text data. The main server 2000 may use the text data resulting from conversion to generate a prompt, which will be described later.

In the meantime, the main server 2000 may transmit speech data to an external server, and the external server may convert the speech data to text data and provide the text data to the main server 2000. Alternatively, the main server 2000 may use speech data to generate a prompt without converting the speech data to text data. In this case, the main server 2000 may not include the STT model 2110.

The TTS model 2130 means a program that converts text data to speech data. The main server 2000 may convert response text data obtained from the AI server 3000 to response speech data. The main server 2000 may transmit response speech data to the electronic device 1000.

In the meantime, the main server 2000 may transmit response text data to an external server, and the external server may convert the response text data to response speech data and provide the response speech data to the main server 2000. Alternatively, the main server 2000 may receive response speech data from the AI server 3000. In this case, the main server 2000 may not include the TTS model 2130.

The database 2150 stores information on various contents printed on a plurality of mediums. For example, the database 2150 may store all of the texts printed on the plurality of mediums and/or images printed on the plurality of mediums by mapping the same to respective mediums.

For each medium, the database 2150 may further store information on pages on which texts and images are printed. For example, the database 2150 may store pieces of required information so that among all the contents of a particular medium, the details of the content printed on a first page and the details of the content printed on a second page are distinguished from each other.

For each page, the database 2150 may further store information on positions within pages on which texts and images are printed. For example, the database 2150 may store pieces of required information so that among the contents printed on a particular page, the details of the content printed at a first position (first coordinates) and the details of the content printed at a second position (second coordinates) are distinguished from each other.

In the meantime, the database 2150 may store user information (e.g., the user's unique identification number, name, age, sex, personality, or family relationship). The user information may be recorded or stored by a manager or guardian. The user information may be used to generate a prompt as will be described later. As the user information is used in generating a prompt, a customized response may be generated for the prompt. In addition, the user information may be used to generate session information, which will be described later.

The main server memory 2100 may be realized in the form of various storage devices, such as a ROM, a RAM, an EPROM, a flash drive, or a hard drive, in terms of hardware.

The main server communication unit 2200 may perform data communication between the main server 2000 and an external device. For example, the main server communication unit 2200 may receive a code image (or code data or context information) from the electronic device 1000. For another example, the main server communication unit 2200 may receive response data (response text data or response speech data) from the AI server (3000. For still another example, the main server communication unit 2200 may transmit response speech data to the electronic device 1000.

The main server communication unit 2200 may be, for example, a wired/wireless local area network (LAN) module, a WAN module, an Ethernet module, a Bluetooth module, a Zigbee module, a Universal Serial Bus (USB) module, an IEEE 1394 module, a Wi-Fi module, a mobile communication module, a satellite communication module or any combination thereof, but is not limited thereto.

The main server control unit 2300 may control the elements of the main server 2000 or execute a program stored in the main server memory 2100.

The main server control unit 2300 may be, for example, a central processing unit (CPU), a graphics processing unit (GPU), a neural processing unit (NPU), a digital signal processor (DSP), a state machine, an application specific integrated circuit (ASIC), a radio-frequency integrated circuit (RFIC) or any combination thereof, but is not limited thereto.

Although not shown in FIG. 4, the main server 2000 may include a main server input unit and a main server output unit. The main server input unit may receive input from a manager that manages the main server 2000, and may be a keyboard, button, mouse, microphone, camera, sensor, touch screen, or any combination thereof, but is not limited thereto. The main server output unit may output information processed by the main server 2000 to the manager, and may be a display, speaker, indicator, or any combination thereof, but is not limited thereto.

The AI server 3000 may include an AI server memory 3100, an AI server communication unit 3200, and an AI server control unit 3300.

The AI server memory 3100 may store information processed by the AI server 3000, and a program executed by the AI server 3000. The AI server 3000 may generate response data for the user's questions or speeches. To this end, a generative model may be stored in the AI server memory 3100.

Herein, the generative model may be a natural language processing model (NLP) or a large language model (LLM) trained with a large corpus of data. The generative model may be generated by training a generative pre-trained transformer (GPT) model that uses the structure of a transformer model. Examples of the generative model include ChatGPT, Bard or Gemini of Google, and Copilot of Microsoft, and these models may be stored in the AI server memory 3100.

In the meantime, the generative model may vary depending on the type of data that the AI server 3000 wishes to generate. For example, when the AI server 3000 wishes to receive a speech prompt from the main server 2000 to generate speech response data, the generative model may be a model, such as WaveNet, for generating speech. For another example, when the main server 2000 provides image data to the AI server 3000 and the AI server 3000 wishes to generate image response data, the generative model may be a model, such as a generative adversarial network (GAN) or a diffusion model, for generating an image. That is, the generative model may generate response data of the data type the same as the received data type (e.g., text, sound, image, or video), for example, receiving text data and generating text response data, or receiving speech data and generating speech response data.

Alternatively, the generative model may generate response data of a different data type than the received data type, for example, receiving text data and generating speech response data, or receiving speech data and generating text response data.

Alternatively, the generative model may receive a plurality of data types simultaneously and generate response data of any one data type. For example, the generative model may receive data including text and sound and output text response data or speech response data.

The AI server memory 3100 may be realized in the form of various storage devices, such as a ROM, a RAM, an EPROM, a flash drive, or a hard drive, in terms of hardware.

The AI server communication unit 3200 may perform data communication between the AI server 3000 and an external device. For example, the AI server communication unit 3200 may receive a prompt from the main server 2000. For another example, the AI server communication unit 3200 may transmit response data (response text data or response speech data) to the main server 2000.

The AI server communication unit 3200 may be, for example, a wired/wireless local area network (LAN) module, a WAN module, an Ethernet module, a Bluetooth module, a Zigbee module, a Universal Serial Bus (USB) module, an IEEE 1394 module, a Wi-Fi module, a mobile communication module, a satellite communication module or any combination thereof, but is not limited thereto.

The AI server control unit 3300 may control the elements of the AI server 3000 or execute a program stored in the AI server memory 3100.

The AI server control unit 3300 may be, for example, a central processing unit (CPU), a graphics processing unit (GPU), a neural processing unit (NPU), a digital signal processor (DSP), a state machine, an application specific integrated circuit (ASIC), a radio-frequency integrated circuit (RFIC) or any combination thereof, but is not limited thereto.

Although not shown in FIG. 5, the AI server 3000 may include an AI server input unit and an AI server output unit. The AI server input unit may receive input from a manager that manages the AI server 3000, and may be a keyboard, button, mouse, microphone, camera, sensor, touch screen, or any combination thereof, but is not limited thereto. The AI server output unit may output information processed by the AI server 3000 to the manager, and may be a display, speaker, indicator, or any combination thereof, but is not limited thereto.

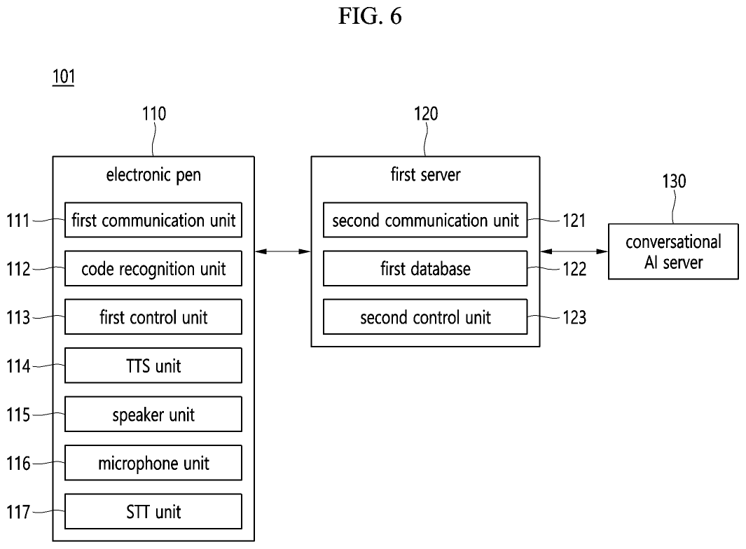

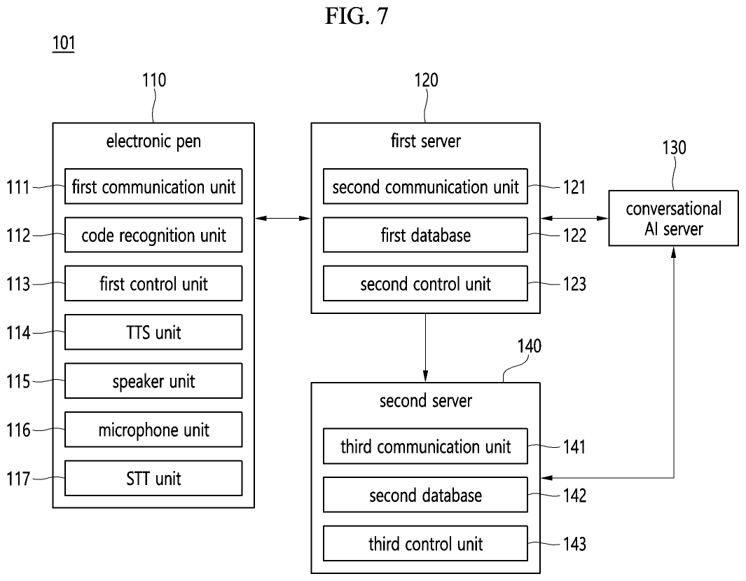

Hereinafter, another embodiment of the above-described interactive system 100 will be described with reference to FIGS. 6 and 7.

FIG. 6 is a block diagram illustrating an electronic pen service system using a conversational AI service according to an embodiment.

Referring to FIG. 6, an electronic pen service system 101 using a conversational AI service includes an electronic pen 110, a first server 120, and a conversational AI server 130. Herein, the electronic pen service system 101 corresponds to the interactive system 100 described with reference to FIGS. 1 to 5, and the electronic pen 110 corresponds to the electronic device 1000, and the first server 120 corresponds to the main server 2000, and the conversational AI server 130 corresponds to the AI server 3000.

The electronic pen 110 includes a first communication unit 111, a code recognition unit 112, a first control unit 113, a TTS unit 114, and a speaker unit 115.

The first communication unit 111 may use a wired or wireless interface to communicate with the first server 120. The first communication unit 111 is substantially the same as the electronic device communication unit 1500 described with reference to FIG. 2.

The code recognition unit 112 recognizes a predetermined code from a printed matter on which the predetermined code is printed. The predetermined code includes position information, i.e., coordinate information, on the printed matter. The code recognition unit 112 includes a camera. When the camera approaches within a predetermined distance from a printed matter on which a predetermined code is printed, the camera captures the predetermined code within a region recognizable by the camera. Afterward, the code recognition unit 112 transmits the image captured by the camera to the first control unit 113. The code recognition unit 112 is substantially the same as the sensing unit 1100 described with reference to FIG. 2.

The first control unit 113 reads (obtains coordinate information corresponding to the pre-determined code in the image from a pre-stored database) coordinate information from the pre-determined code in the image received from the code recognition unit 112. The first control unit 113 is substantially the same as the electronic device control unit 1600 described with reference to FIG. 2.

Afterward, the first control unit 113 transmits the read coordinate information to the first server 120 through the first communication unit 111.

As will be described later, the first communication unit 111 receives a result value for the transmitted coordinate information from the first server 120.

In the meantime, the first control unit 1130 may read region identification information from the predetermined code in the image received from the code recognition unit 112.

Region identification information is information for identifying a region in the medium. For example, the medium may include at least one page, and a content may be printed on each page. Herein, region identification information may be set for a particular region within a page. In this case, the region identification information may be encoded in a code image obtained by capturing the particular region. Herein, the particular region may be a region on which a particular figure is printed, a region in which text is printed, or a region in which an illustration is printed.

Region identification information may be used in place of coordinate information. For example, the first control unit 113 may transmit the read region identification information to the first server 120 through the first communication unit 111. In this case, the first server 120 may transmit a prompt corresponding to the region identification information to the conversational AI server 130, and the conversational AI server 130 may generate a result value for the received prompt and transmit the result value to the first server 120.

The TTS unit 114 is an element equipped with a text-to-speech (TTS) function, and performs a function of converting text to speech. The TTS unit 114 converts a result value received by the first communication unit 111 to speech, and the speech resulting from conversion is output to the user of the electronic pen 110 through the speaker unit 115. The TTS unit 114 is an element corresponding to the TTS model 2130 described with reference to FIG. 4. The TTS unit 114 may be included in the first server 120 rather than the electronic pen 110. In this case, the electronic pen 110 may receive speech resulting from converting a result value from the first server 120, and may output the speech resulting from conversion to the speaker unit 115.

In an additional embodiment, the electronic pen 110 may further include a microphone 116 and an STT unit 117.

The electronic pen 110 receives a speech input of the user of the electronic pen 110 through the microphone 116.

The STT unit 117 is an element equipped with a speech-to-text (STT) function, and performs a function of converting speech to text. The STT unit 117 converts speech information received by the microphone 116 to character information, and transmits the character information resulting from conversion to the first server 120. Afterward, the first communication unit 111 receives, from the first server 120, a result value for the transmitted characters as characters, and the characters received by the first communication unit 111 may be converted to speech and the speech is output to the user of the electronic pen 110 through the speaker unit 115. The STT unit 117 is an element corresponding to the STT model 2110 described with reference to FIG. 4. The STT unit 117 may be included in the first server 120 rather than the electronic pen 110. In this case, the electronic pen 110 may transmit a speech signal to the first server 120, and the first server 120 may use the STT unit 117 to convert the speech signal to character information.

In addition, in still another embodiment, the electronic pen 110 may further include a storage unit 118.

The storage unit 118 includes a content specified in coordinate information. The storage unit 118 may be included in the first server 120 rather than the electronic pen 110.

The first control unit 113 may read coordinate information from a predetermined code captured from an image received from the code recognition unit 112, and may extract a content stored in the read coordinate information, and may output the extracted content to the user through the speaker unit 115.

In an embodiment of the present disclosure, with coordinate information and character information transmitted to the first server 120, ID information of the user of the electronic pen 110 and ID information of the electronic pen 110 are included.

The first server 120 includes a second communication unit 121, a first database 122, and a second control unit 123.

When the second communication unit 121 receives coordinate information from the electronic pen 110, the second control unit 123 stores the coordinate information in the first database 122. The second communication unit 121 is substantially the same as the main server communication unit 2200 described with reference to FIG. 4.

The first database 122 may pre-store a prompt corresponding to coordinate information. A prompt means input data for giving a command or instruction to the conversational AI server 130. The first database 122 is an element corresponding to the database 2150 described with reference to FIG. 4. The first database 122 may store information on the medium. For example, the first database 122 may include at least one selected from the group of a medium ID of each of the plurality of mediums, a medium title, all texts printed on a medium, text printed on a particular page of a medium, and text printed at particular coordinates of a medium. In addition, the first database 122 may store a pre-determined prompt and/or prompt template.

The second control unit 123 extracts a prompt corresponding to received coordinate information, and transmits the extracted prompt to the conversational AI server 130. The second control unit 123 is substantially the same as the main server control unit 2300 described with reference to FIG. 4. The second control unit 133 may load a prompt from the first database 122. Alternatively, the second control unit 123 may load a prompt template and information on the medium from the first database 122 to generate a prompt.

When the second communication unit 121 receives character information from the electronic pen 110, the second control unit 123 stores the character information in the first database 122 and transmits the received character information to the conversational AI server 130.

The conversational AI server 130 is a server in which a language processing model for using AI is embedded, and means a server for providing a conversational AI service.

Examples of the conversational AI service include ChatGPT of OpenAI, Bard or Gemini of Google, and Copilot of Microsoft.

The conversational AI server 130 uses the language processing model with a prompt or character information from the first server 120 as an input value to extract a result value, and transmits the extracted result value to the first server 120. The result value consists of string data.

The second communication unit 121 receives a result value from the conversational AI server 130, and transmits the result value to the electronic pen 110.

A session means a series of processes of transmitting character information or a prompt to the conversational AI server 130 and receiving a result value therefor. When one session is terminated, the second control unit 123 associates a received result value with the session ID, the character information or prompt transmitted to the conversational AI server 130, and the ID of the user and the electronic pen 110 that has sent the code information on which the character information or prompt is based, so as to generate session information, and stores the session information in the first database 122. The second control unit 123 stores these pieces of information in the form of a JSON file, and may further store time information for the session ID in addition thereto.

Session information may include text resulting from converting a speech signal of the user, a prompt generated by the first server 120, and a result value generated by the conversational AI server 130. The second control unit 123 extracts at least one piece of session information stored in the first database 122 based on a user ID or an electronic pen ID for a predetermined period. The second control unit 123 transmits pre-determined session prompt information and the extracted at least one piece of session information to the conversational AI server 130 through the second communication unit 121. A pre-determined session prompt may include the details related to a summary of at least one piece of session information. In addition, a pre-determined session prompt may include the details related to analysis of at least one piece of session information.

The conversational AI server 130 uses the language processing model with a session prompt received from the first server 120 as an input value to extract a result value, and transmits the extracted result value to the first server 120.

More specifically, the first server 120 uses session information to generate a session prompt, and transmits the generated session prompt to the conversational AI server 130. The conversational AI server 130 may receive the session prompt to output at least one selected from the group of a conversation log, a conversation summary, a pronunciation evaluation, a keyword that the user frequently uses, the user's medium use time, the user's medium type-specific use time, and the user's interest. The conversational AI server 130 may provide output analysis information to the first server 120.

The first server 120 stores a result value (or analysis information) for a received session prompt in the first database 122. The first server 120 provides at least one piece of session information and a result value for a session prompt to the user upon the user's request.

Specifically, the first server 120 may transmit analysis information to a guardian (e.g., if the user is a child, the guardian is a parent of the child)'s terminal (e.g., a laptop computer, a desktop computer, or a smartphone). The guardian may view the analysis information via his or her terminal.

In the meantime, the first server 120 may generate analysis information by using session information without using the conversational AI server 130. The analysis information may include at least one selected from the group of a conversation log indicating a conversation between the user and the electronic pen 110, a conversation summary summarizing a conversation between the user and the electronic pen 110, pronunciation evaluation information indicating an evaluation of the user's pronunciation, a keyword that the user frequently uses, the user's medium use time, the user's medium type-specific use time, and the user's interest field. FIG. 7 is a block diagram illustrating an electronic pen service system using a conversational AI service according to another embodiment.

Referring to FIG. 7, an electronic pen service system 101 using a conversational AI service includes an electronic pen 110, a first server 120, a conversational AI server 130, and a second server 140. Herein, the electronic pen service system 101 corresponds to the interactive system 100, and the electronic pen 110 corresponds to the electronic device 1000, and the first server 120 corresponds to the main server 2000, and the conversational AI server 130 corresponds to the AI server 3000. The difference between FIG. 6 and FIG. 7 is that the second server 140 is further included in FIG. 7. The second server 140 may perform obtaining session information, generating a session prompt, and obtaining analysis information described above.

The electronic pen 110 includes a first communication unit 111, a code recognition unit 112, a first control unit 113, a TTS unit 114, and a speaker unit 115.

The first communication unit 111 may use a wired or wireless interface to communicate with the first server 120. The first communication unit 111 is substantially the same as the electronic device communication unit 1500 described with reference to FIG. 2.

The code recognition unit 112 recognizes a predetermined code from a printed matter on which the predetermined code is printed. The predetermined code includes position information, i.e., coordinate information, on the printed matter. The code recognition unit 112 includes a camera. When the camera approaches within a predetermined distance from a printed matter on which a predetermined code is printed, the camera captures the predetermined code within a region recognizable by the camera. Afterward, the code recognition unit 112 transmits the image captured by the camera to the first control unit 113. The code recognition unit 112 is substantially the same as the sensing unit 1100 described with reference to FIG. 2.

The first control unit 113 reads coordinate information from the predetermined code in the image received from the code recognition unit 112. The first control unit 113 is substantially the same as the electronic device control unit 1600 described with reference to FIG. 2.

Afterward, the first control unit 113 transmits the read coordinate information to the first server 120 through the first communication unit 111.

As will be described later, the first communication unit 111 receives a result value for the transmitted coordinate information from the first server 120.

In the meantime, region identification information may be used in place of coordinate information. For example, the first control unit 113 may transmit the read region identification information to the first server 120 through the first communication unit 111. In this case, the first server 120 may transmit a prompt corresponding to the region identification information to the conversational AI server 130, and the conversational AI server 130 may generate a result value for the received prompt and transmit the result value to the first server 120.

The TTS unit 114 is an element equipped with a text-to-speech (TTS) function, and performs a function of converting text to speech. The TTS unit 114 converts a result value received by the first communication unit 111 to speech, and the speech resulting from conversion is output to the user of the electronic pen 110 through the speaker unit 115. The TTS unit 114 is an element corresponding to the TTS model 2130 described with reference to FIG. 4. The TTS unit 114 may be included in the first server 120 rather than the electronic pen 110. In this case, the electronic pen 110 may receive speech resulting from converting a result value from the first server 120, and may output the speech resulting from conversion to the speaker unit 115.

In an additional embodiment, the electronic pen 110 may further include a microphone 116 and an STT unit 117.

The electronic pen 110 receives a speech input of the user of the electronic pen 110 through the microphone 116.

The STT unit 117 is an element equipped with a speech-to-text (STT) function, and performs a function of converting speech to text. The STT unit 117 converts speech information received by the microphone 116 to character information, and transmits the character information resulting from conversion to the first server 120. Afterward, the first communication unit 111 receives, from the first server 120, a result value for the transmitted characters as characters, and the characters received by the first communication unit 111 may be converted to speech and the speech is output to the user of the electronic pen 110 through the speaker unit 115. The STT unit 117 is an element corresponding to the STT model 2110 described with reference to FIG. 4. The STT unit 117 may be included in the first server 120 rather than the electronic pen 110. In this case, the electronic pen 110 may transmit a speech signal to the first server 120, and the first server 120 may use the STT unit 117 to convert the speech signal to character information.

In addition, in still another embodiment, the electronic pen 110 may further include a storage unit 118.

The storage unit 118 includes a content specified in coordinate information. The storage unit 118 may be included in the first server 120 rather than the electronic pen 110.

The first control unit 113 may read coordinate information from a predetermined code captured from an image received from the code recognition unit 112, and may extract a content stored in the read coordinate information, and may output the extracted content to the user through the speaker unit 115.

In an embodiment of the present disclosure, with coordinate information and character information transmitted to the first server 120, ID information of the user of the electronic pen 110 and ID information of the electronic pen 110 are included.

The first server 120 includes a second communication unit 121, a first database 122, and a second control unit 123.

When the second communication unit 121 receives coordinate information from the electronic pen 110, the second control unit 123 stores the coordinate information in the first database 122. The second communication unit 121 is substantially the same as the main server communication unit 2200 described with reference to FIG. 4.

The first database 122 may pre-store a prompt corresponding to coordinate information. A prompt means input data for giving a command or instruction to the conversational AI server 130. The first database 122 is an element corresponding to the database 2150 described with reference to FIG. 4. The first database 122 may store information on the medium. For example, the first database 122 may include at least one selected from the group of a medium ID of each of the plurality of mediums, a medium title, all texts printed on a medium, text printed on a particular page of a medium, and text printed at particular coordinates of a medium. In addition, the database 2150 may store a pre-determined prompt and/or prompt template.

The second control unit 123 extracts a prompt corresponding to received coordinate information, and transmits the extracted prompt to the conversational AI server 130. The second control unit 123 is substantially the same as the main server control unit 2300 described with reference to FIG. 4. The second control unit 133 may load a prompt from the first database 122. Alternatively, the second control unit 123 may load a prompt template and information on the medium from the first database 122 to generate a prompt.

When the second communication unit 121 receives character information from the electronic pen 110, the second control unit 123 stores the character information in the first database 122 and transmits the received character information to the conversational AI server 130.

The conversational AI server 130 is a server in which a language processing model for using AI is embedded, and means a server for providing a conversational AI service.

Examples of the conversational AI service include ChatGPT of OpenAI, Bard or Gemini of Google, and Copilot of Microsoft.

The conversational AI server 130 uses the language processing model with a prompt or character information from the first server 120 as an input value to extract a result value, and transmits the extracted result value to the first server 120. The result value consists of string data.

The second communication unit 121 receives a result value from the conversational AI server 130, and transmits the result value to the electronic pen 110.

In addition, the second communication unit 121 transmits a result value to the second server 140.

The second server 140 includes a third communication unit 141, a second database 142, and a third control unit 143.

The third communication unit 141 receives a result value from the first server 120, and stores the result value in the second database 142.

A session means a series of processes of transmitting character information or a prompt to the conversational AI server 130 and receiving a result value therefor. When one session is terminated, the third control unit 143 associates a received result value with the session ID, the character information or prompt transmitted to the conversational AI server 130, and the ID of the user and the electronic pen 110 that has sent the code information on which the character information or prompt is based, so as to generate session information, and stores the session information in the second database 142. The third control unit 143 stores these pieces of information in the form of a JSON file, and may further store time information for the session ID in addition thereto.

The third control unit 143 extracts at least one piece of session information stored in the second database 142 based on a user ID or an electronic pen ID for a predetermined period.

The third control unit 143 transmits pre-determined session prompt information and the extracted at least one piece of session information to the conversational AI server 130 through the third communication unit 141. A pre-determined session prompt may include the details related to a summary of at least one piece of session information. In addition, a pre-determined session prompt may include the details related to analysis of at least one piece of session information.

The conversational AI server 130 uses the language processing model with a session prompt received from the second server 140 as an input value to extract a result value, and transmits the extracted result value to the second server 140.

The second server 140 stores a result value for a received session prompt in the second database 142. The second server 140 provides at least one piece of session information and a result value for a session prompt to the user upon the user's request.

### 3. Information Used in Interactive System

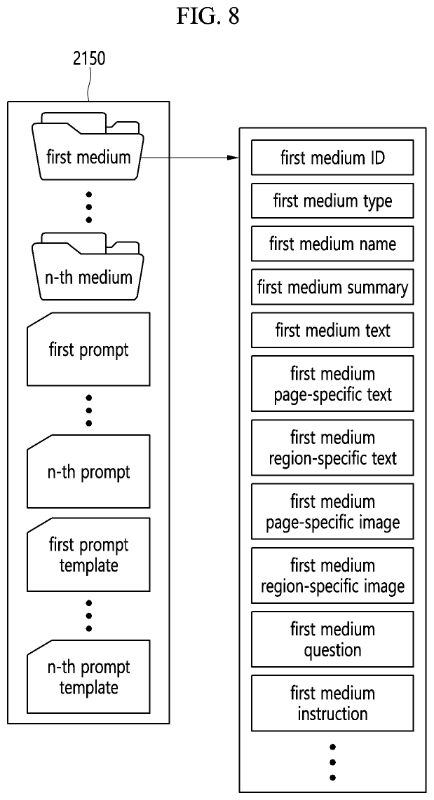

Hereinafter, information stored in the database 2150 of the interactive system 100 will be described with reference to FIG. 8.

FIG. 8 is a diagram illustrating pieces of information stored in the database 2150 according to an embodiment. Pieces of information stored in the database 2150 may be used by the main server 2000, and in particular, may be used by the main server 2000 to generate a prompt.

Referring to FIG. 8, the database 2150 may store information on a medium (information of a first medium to information on an n-th medium), a prompt (a first prompt to an n-th prompt), and a prompt template (a first prompt template to an n-th prompt template).

Information on a medium may be used to generate a prompt, as will be described later. Information on a medium may be understood as information for recognizing what medium the user is using or what part the user is interested in.

Information on a first medium is information on the first medium of the plurality of mediums. Information on the first medium may include a first medium ID, a first medium type, a first medium name, a first medium summary, a first medium text, a first medium page-specific text, a first medium region-specific text, a first medium page-specific image, a first medium region-specific image, a first medium question, and a first medium instruction.

The first medium ID is information for identifying the first medium among the plurality of mediums. The first medium may be assigned a first unique identification number, and the first unique identification number may be, that is, the first medium ID.

The first medium type means the form of the medium, and may be a book, a card, or a map.

The first medium name is information that names the first medium. When the first medium is a book, the first medium name is the title of the book. When the first medium is a card, the first medium name means the name of the card.

The first medium summary is information that summarizes a content of the first medium. When the first medium is a book, the first medium summary is a summary of a story printed on the book. When the first medium is a card, the first medium summary is omitted or a summary of a content printed on the card.

The first medium text is information on a content of the first medium. When the first medium is a book, the first medium text means the entire text (or story or writing) printed on the first medium or text of part thereof.

When the first medium is a book, the first medium page-specific text is text printed on each page of the book. When the first medium is a card, the first medium page-specific text is a picture printed on the front or the back of the card.

The first medium region-specific text is text printed in a particular region on a particular page (or a particular side) of the first medium. When the first medium is a book, the first medium region-specific text is text (paragraph or sentence) printed in a particular region on a particular page of the first medium. When the first medium is a card, the first medium region-specific text is text printed in a particular region on the front or the back of the card. Herein, a particular region may be preset when information on each medium is stored, and may have various shapes, such as a polygon, a circle, an ellipse, or any figure.

When the first medium is a book, the first medium page-specific image is an illustration printed on each page of the book. When the first medium is a card, the first medium page-specific image is an illustration printed on the front or the back of the card.

The first medium region-specific image is an illustration printed in a particular region on a particular page (or a particular side) of the first medium. When the first medium is a book, the first medium region-specific image is an illustration printed in a particular region on a particular page of the first medium. When the first medium is a card, the first medium region-specific image is an illustration printed in a particular region on the front or the back of the card. Herein, a particular region may be preset when information on each medium is stored, and may have various shapes, such as a polygon, a circle, an ellipse, or any figure.

The first medium page-specific text, the first medium region-specific text, the first medium page-specific image, and the first medium region-specific image may be understood as medium context information. For example, as will be described later, when the user uses the electronic device 1000 to speak or ask questions while touching or pointing at a particular page of the first medium or text or image on the particular page, the main server 2000 may obtain at least one selected from the group of the first medium page-specific text, the first medium region-specific text, the first medium page-specific image, and the first medium region-specific image as medium context information, and may use the medium context information to generate a prompt.

The first medium question is a question printed on the first medium.

When the first medium is a book, the first medium question may include questions about a story of the first medium. For example, the first medium question may include a quiz about a story of the first medium or a question asking about a main character's feeling. In the first medium, different questions may be printed on pages. Specifically, on each page in the first medium, questions about text printed on that page may be printed.

When the first medium is a card, the first medium question may include questions related to a content of the first medium. For example, when a content of the first medium is “Self-introduction”, the first medium question may include “What is your name?”, and/or “What are your hobbies?”.

The first medium instruction is an instruction printed on the first medium.

When the first medium is a book, the first medium instruction may include instructions about a story of the first medium. For example, the first medium instruction may include “Express the user's thoughts”, and “Talk about the user's experience” about a story of the first medium. In the first medium, different instructions may be printed on pages. Specifically, on each page in the first medium, instructions about text printed on that page may be printed.

When the first medium is a card, the first medium instruction may include instructions related to a content of the first medium. For example, when a content of the first medium is “Future aspirations”, the first medium instruction may include “Talk about someone you want to be like”, and “Talk about something you are good at”.

The first medium question or the first medium instruction may be understood as artificial context information. For example, as will be described later, when the user uses the electronic device 1000 to touch or point at a region on which a question is printed in the first medium, the main server 2000 may obtain the first medium question or the first medium instruction or both as artificial context information and use the artificial context information to generate a prompt.

In the meantime, information on a medium may include a sound, an image, or a video in addition to text. For example, the database 2150 may include speech about a medium summary, speech about text (text printed on each page or each region) printed on a medium, and speech about a question or an instruction printed on a medium. Further, the database 2150 may include a video related to a medium, a video related to each page of a medium, and a video related to a region of a medium or a printed image. Accordingly, context information, which will be described later, may include at least one selected from the group of text, a sound, an image, and a video.

A prompt means information input to the AI server 3000. The AI server 3000 may receive a prompt and generate a response thereto. A prompt may include context information. A prompt stored in the database 2150 may include context information related to a particular medium.

A specific example of a prompt will be described later.

A prompt template may include the details for generating a prompt. Specifically, a prompt template may include a sentence or a paragraph for enabling the AI server 3000 to be aware of a context. A prompt template is modified (e.g., context information is added) using additional information, such as context information, to become a prompt to be input to the AI server 3000.

The main server 2000 may generate a prompt using a prompt template and text data resulting from converting speech data of the user. Alternatively, the main server 2000 may generate a prompt using a prompt template and medium context information. Alternatively, the main server 2000 may generate a prompt using a prompt template and artificial context information. Alternatively, the main server 2000 may generate a prompt using a prompt template, artificial context information, and medium context information.

A specific example of a prompt template will be described later.

In the meantime, in addition to the above-described pieces of information, the database 2150 may further include other pieces of information. In addition, the forms in which pieces of information are stored in the database 2150 are not limited to the above-described forms, and there may be various ways in which pieces of information are stored (e.g., a category, and an association between pieces of information).

Hereinafter, a process of obtaining context information will be described. As described above, context information means information related to a region in which the user interacts with a medium by using the electronic device 1000. Context information may be used to generate a prompt.

When the user uses the electronic device 1000 to interact with a medium, the user may use the electronic device 1000 to touch or point at a particular region within the medium. For example, when the user positions the electronic device 1000 in contact with or near a particular region within a medium, the sensing unit 1100 of the electronic device 1000 may capture the particular region to obtain a code image.

A code image may be analyzed by the electronic device 1000 or the main server 2000, and code data may be obtained, accordingly.

The main server 2000 may obtain reference information from code data. Herein, reference information means information for loading required information from the database 2150. For example, the reference information may include at least one selected from the group of a medium ID, page information, and position information (coordinate information and/or region identification information).

The main server 2000 may use reference information to search the database 2150 for required information and obtain the required information as context information. Context information may include information corresponding to at least part of text or an illustration printed on a medium. The main server 2000 may use at least context information to generate a prompt.

Information included in context information may be determined based on a region of a medium in which the electronic device 1000 is touched or positioned. In other words, when the user positions the electronic device 1000 in different regions within a medium, pieces of context information consequently obtained by the main server 2000 need to be different from each other. This means that different codes are printed in respective regions within a medium and code images obtained by the electronic device 1000 are also different from each other.

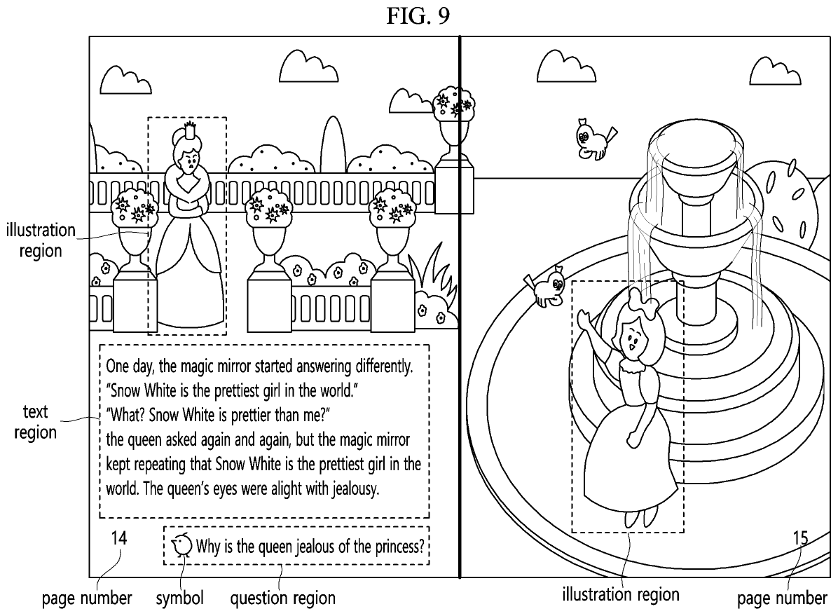

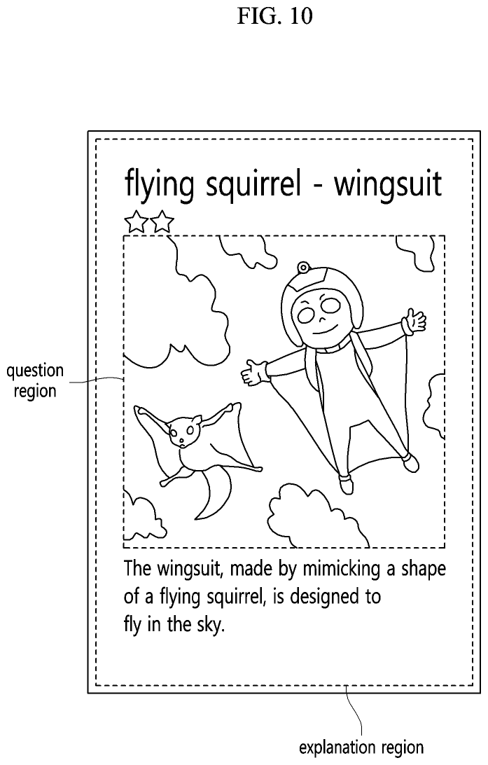

Hereinafter, an aspect in which regions within a medium are distinguished will be described with reference to FIGS. 9 and 10.

FIG. 9 is a diagram illustrating an aspect in which regions are distinguished in a medium, according to an embodiment.

Referring to FIG. 9, a medium may include an illustration region, a text region, a question region, a page number, and a symbol. Codes printed on respective regions may have different patterns. For example, when code data obtained by capturing codes printed in respective regions is decoded, different pieces of region identification information may be obtained.

An illustration region is a region in which a particular illustration is printed. When code data obtained by the electronic device 1000 touching an illustration region is decoded, at least a medium ID, page information, and region identification information indicating the illustration region may be obtained. The main server 2000 may use the obtained medium ID, page information, and region identification information to obtain an image corresponding to an illustration printed in that region from the database 2150.

A text region is a region in which text(or writing, written content, story) is printed. When code data obtained by the electronic device 1000 touching a text region is decoded, at least a medium ID, page information, and region identification information indicating the text region may be obtained. The main server 2000 may use the obtained medium ID, page information, and region identification information to obtain text corresponding to text printed in that region from the database 2150.

In the meantime, a text region may be set for each of the sentences that constitute text. In this case, a plurality of text regions may be set within one page.

A question region is a region in which a question is printed. When code data obtained by the electronic device 1000 touching a question region is decoded, at least a medium ID, page information, and region identification information indicating the question region may be obtained. The main server 2000 may use the obtained medium ID, page information, and region identification information to obtain text corresponding to a question printed in that region from the database 2150.

In the meantime, at least one selected from the group of a symbol, a question, and an instruction may be printed in a question region, and a question region may be named differently depending on the printed details. For example, when an instruction is printed, the question region may be named as an instruction region. Alternatively, when only a symbol is printed, the question region may be named as a symbol region.

Regions distinguished from each other in a medium are not limited to the above-described regions, and a unit and a rule for distinguishing regions may be determined in a variety of ways.

FIG. 10 is a diagram illustrating an aspect in which regions are distinguished in a medium, according to another embodiment.

Referring to FIG. 10, in a medium, a question region and an explanation region may be distinguished from each other. An image may be printed in the question region, and text may be printed in the explanation region. Codes printed on respective regions may have different patterns. For example, when code data obtained by capturing codes printed in respective regions is decoded, different pieces of region identification information may be obtained.

When code data obtained by the electronic device 1000 touching a question region is decoded, at least a medium ID and region identification information indicating the question region may be obtained. The main server 2000 may use the obtained medium ID and region identification information to obtain text corresponding to a question related to that medium from the database 2150.

When code data obtained by the electronic device 1000 touching an explanation region is decoded, at least a medium ID and region identification information indicating the explanation region may be obtained. The main server 2000 may use the obtained medium ID and region identification information to obtain text corresponding to an explanation related to that medium from the database 2150.

Regions distinguished from each other in a medium are not limited to the above-described regions, and types of regions, shapes of figures specifying regions, and patterns of codes printed in regions may be determined in a variety of ways.

### 4. Interaction Using Artificial Context Information

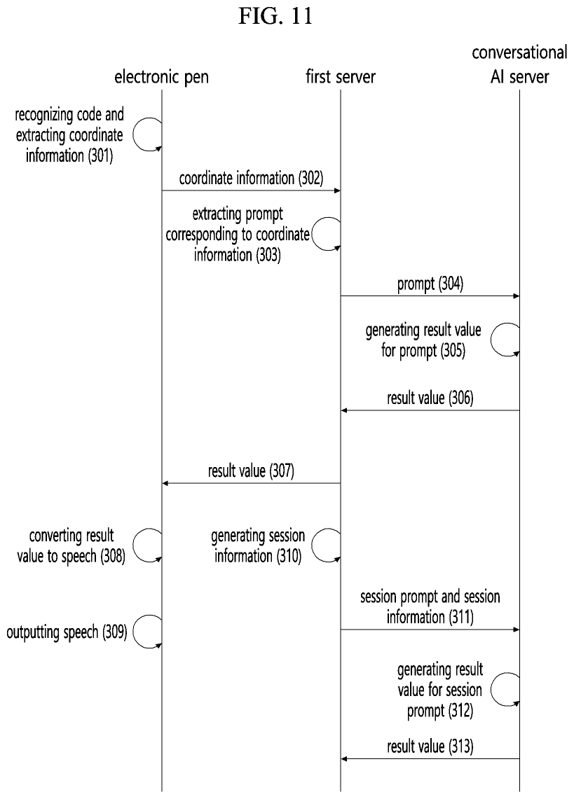

Hereinafter, a method in which the interactive system 100 uses artificial context information to assist a user to use a medium will be described with reference to FIGS. 11 to 22.

The primary purpose of a medium is to tell a user a particular story or information, such as a fairy tale, nature, animal, or science. In the meantime, beyond simply transferring a particular story or information, a medium may be produced to include details, such as questions, instructions, exercises, or exploratory activities, so that the user can understand the details of the medium in depth.

In this case, with assistance from a guardian, the user is only able to answer questions or perform instructions and is unable to additional learning or exploration thereafter. Therefore, assisting a user to use a medium on behalf of a guardian may deepen the user's understanding about a story or content printed on a medium and increase the user's interest.

Hereinafter, the interactive system 100 for assisting a user to use a medium on behalf of a guardian will be described, particularly focusing on how the interactive system 100 generates a prompt for interaction when a story or information as well as an additional question or instruction are printed on a medium.

A method of assisting a user to use a medium by using artificial context information considers the following scenario, for example. A child is reading a storybook without a guardian, and a story as well as quizzes or additional questions about the story are printed on the storybook, and the child wishes to have a conversation about the quizzes or additional questions using the interactive system 100.

FIG. 11 is a flowchart illustrating a method of assisting a user to use a medium by using artificial context information according to a first embodiment. Hereinafter, as described above with reference to FIG. 6, the electronic device 1000 is named as the electronic pen 110, the main server 2000 is named as the first server 120, and the AI server 3000 is named as the conversational AI server 130. The details described with reference to FIG. 6 may be applied in the same way to each element.

Referring to FIG. 11, in step 301, the electronic pen recognizes a predetermined code from a printed matter on which the predetermined code is printed and extracts coordinate information. The predetermined code includes position information, i.e., coordinate information, on the printed matter. The electronic pen includes a camera. When the camera approaches within a predetermined distance from a printed matter on which a predetermined code is printed, the camera captures the predetermined code within a region recognizable by the camera. Afterward, the electronic pen reads the coordinate information from the predetermined code in a captured image.

In step 302, the electronic pen transmits the read coordinate information to the first server. Alternatively, the electronic pen transmits the captured image to the first server, and the first server analyzes the captured image to obtain code data and obtains at least a medium ID and coordinate information from the obtained code data. Herein, page information may be further obtained from the code data.

The electronic pen may further transmit ID information of the electronic pen user and ID information of the electronic pen to the first server.

The first server associates and stores the received coordinate information, ID information of the electronic pen user, and ID information of the electronic pen.

In step 303, the first server extracts a prompt corresponding to the coordinate information.

The prompt corresponding to the coordinate information may be pre-stored in the first server. A prompt means input data for giving a command or instruction to the conversational AI server. The first server may obtain a prompt corresponding to the medium ID, a prompt corresponding to the coordinate information, or a prompt corresponding to the medium ID and the coordinate information from the first database.

Alternatively, the first server may search the first database for information corresponding to the medium ID among pieces of information on the medium and the coordinate information, and may obtain the found information as context information. Herein, in obtaining the context information, the first server may further consider page information.

The first server may use the context information to generate a prompt. For example, the first server may add details to the context information to generate a prompt. For another example, the first server may obtain a prompt template corresponding to at least one selected from the group of the medium ID, the page information, and the coordinate information, and may use the context information and the prompt template to generate a prompt.

In step 304, the first server transmits the extracted prompt to the conversational AI server.

The conversational AI server is a server in which a language processing model for using AI is embedded, and means a server for providing a conversational AI service. Examples of the conversational AI service include ChatGPT of OpenAI, Bard or Gemini of Google, and Copilot of Microsoft.

In step 305, the conversational AI server uses the language processing model with the prompt received from the first server as an input value and generates and extracts a result value.

The result value consists of string data.

In step 306, the conversational AI server transmits the extracted result value to the first server.

In step 307, the first server transmits the received result value to the electronic pen.

In step 308, the electronic pen uses a function of converting text to speech to convert the received result value to speech.

In step 309, the electronic pen outputs the speech resulting from conversion to the user of the electronic pen.

In step 310, the first server generates session information.

A session means a series of processes of transmitting a prompt to the conversational AI server and receiving a result value therefor. When one session is terminated, the first server associates a received result value with the session ID, the prompt transmitted to the conversational AI server, and the ID of the user and the electronic pen that has sent the code information on which the prompt is based on, so as to generate session information. In addition, the first server stores this. The first server stores these pieces of information in the form of a JSON file, and may further store time information for the session ID in addition thereto.

In step 311, the first server extracts at least one piece of session information stored based on the user ID or electronic pen ID for a pre-determined period, and transmits pre-determined session prompt information and the extracted at least one piece of session information to the conversational AI server.

A pre-determined session prompt may include the details related to a summary of at least one piece of session information. In addition, a pre-determined session prompt may include the details related to analysis of at least one piece of session information.

In step 312, the conversational AI server uses the language processing model with the session prompt received from the first server as an input value and generates a result value.

In step 313, the conversational AI server transmits the generated result value to the first server.

The first server stores the result value for the received session prompt. The first server provides at least one piece of session information and a result value for a session prompt to the user upon the user's request.

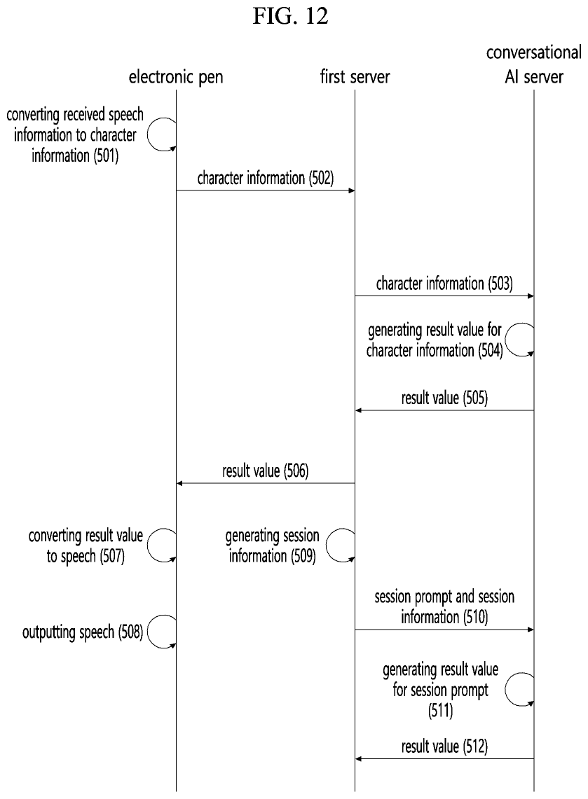

FIG. 12 is a flowchart illustrating a method of assisting a user to use a medium by using artificial context information according to a second embodiment of the present disclosure. Hereinafter, as described above with reference to FIG. 6, the electronic device 1000 is named as the electronic pen 110, the main server 2000 is named as the first server 120, and the AI server 3000 is named as the conversational AI server 130. The details described with reference to FIG. 6 may be applied in the same way to each element.

Referring to FIG. 12, in step 501, the electronic pen receives a speech input of the user through the microphone, and converts speech information to character information.

In step 502, the electronic pen transmits the character information resulting from conversion to the first server.

The first server associates and stores the received character information, ID information of the electronic pen user, and ID information of the electronic pen.

The first server may use the character information to generate a prompt. For example, the first server may obtain a prompt template corresponding to the medium ID from the first database, and may use the prompt template and the character information to generate a prompt. For another example, the first server may add details to the character information or modify the character information to generate a prompt. For still another example, the first server may use a prompt generated before the character information is obtained, and the character information to generate a new prompt.

In step 503, the first server transmits the character information to the conversational AI server. The first server may transmit the prompt to the AI server.

The conversational AI server is a server in which a language processing model for using AI is embedded, and means a server for providing a conversational AI service. Examples of the conversational AI service include ChatGPT of OpenAI, Bard or Gemini of Google, and Copilot of Microsoft.

In step 504, the conversational AI server uses the language processing model with the character information received from the first server as an input value and generates and extracts a result value. Alternatively, the conversational AI server may use the prompt received from the first server as an input value and generate a result value.

The result value consists of string data.

In step 505, the conversational AI server transmits the extracted result value to the first server.

In step 506, the first server transmits the received result value to the electronic pen.

In step 507, the electronic pen uses a function of converting text to speech to convert the received result value to speech.

In step 508, the electronic pen outputs the speech resulting from conversion to the user of the electronic pen.

In step 509, the first server generates session information.

A session means a series of processes of transmitting character information to the conversational AI server and receiving a result value therefor. When one session is terminated, the first server associates a received result value with the session ID, the character information transmitted to the conversational AI server, and the ID of the user and the electronic pen that has input the speech on which the character information is based on, so as to generate session information. In addition, the first server stores this. The first server stores these pieces of information in the form of a JSON file, and may further store time information for the session ID in addition thereto.

In step 510, the first server extracts at least one piece of session information stored based on the user ID or electronic pen ID for a pre-determined period, and transmits pre-determined session prompt information and the extracted at least one piece of session information to the conversational AI server.

A pre-determined session prompt may include the details related to a summary of at least one piece of session information. In addition, a pre-determined session prompt may include the details related to analysis of at least one piece of session information.

In step 511, the conversational AI server uses the language processing model with the session prompt received from the first server as an input value and generates a result value.

In step 512, the conversational AI server transmits the generated result value to the first server.

The first server stores the result value for the received session prompt. The first server provides at least one piece of session information and a result value for a session prompt to the user upon the user's request.

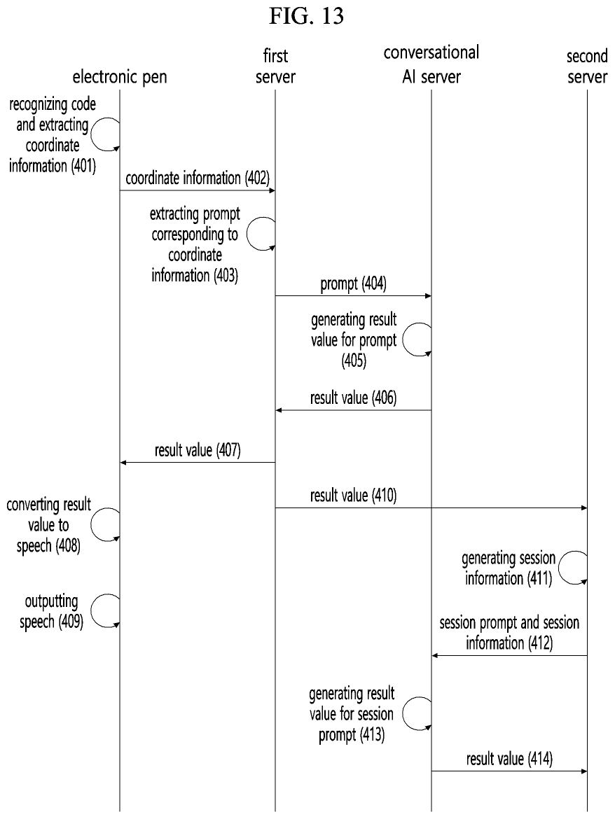

FIG. 13 is a flowchart illustrating a method of assisting a user to use a medium by using artificial context information according to a third embodiment of the present disclosure. Hereinafter, as described above with reference to FIG. 7, the electronic device 1000 is named as the electronic pen 110, the main server 2000 is named as the first server 120, and the AI server 3000 is named as the conversational AI server 130. The details described with reference to FIG. 7 may be applied in the same way to each element.

Referring to FIG. 13, in step 401, the electronic pen recognizes a predetermined code from a printed matter on which the predetermined code is printed and extracts coordinate information. The predetermined code includes position information, i.e., coordinate information, on the printed matter. The electronic pen includes a camera. When the camera approaches within a predetermined distance from a printed matter on which a predetermined code is printed, the camera captures the predetermined code within a region recognizable by the camera. Afterward, the electronic pen reads the coordinate information from the predetermined code in a captured image.

In step 402, the electronic pen transmits the read coordinate information to the first server.

The electronic pen may further transmit ID information of the electronic pen user and ID information of the electronic pen to the first server.

The first server associates and stores the received coordinate information, ID information of the electronic pen user, and ID information of the electronic pen.

In step 403, the first server extracts a prompt corresponding to the coordinate information.

The prompt corresponding to the coordinate information is pre-stored in the first server. A prompt means input data for giving a command or instruction to the conversational AI server.

In step 404, the first server transmits the extracted prompt to the conversational AI server.

The conversational AI server is a server in which a language processing model for utilizing AI is embedded, and also means a server for providing a conversational AI service. Examples of the conversational AI service include ChatGPT of OpenAI, Bard or Gemini of Google, and Copilot of Microsoft.

In step 405, the conversational AI server uses the language processing model with the prompt received from the first server as an input value and generates and extracts a result value.

The result value consists of string data.

In step 406, the conversational AI server transmits the extracted result value to the first server.

In step 407, the first server transmits the received result value to the electronic pen.

In step 408, the electronic pen uses a function of converting text to speech to convert the received result value to speech.

In step 409, the electronic pen outputs the speech resulting from conversion to the user of the electronic pen.

In step 410, the first server transmits the received result value to the second server.

In step 411, the second server generates session information.

A session means a series of processes of transmitting a prompt to the conversational AI server and receiving a result value in response. When one session is terminated, the first server associates a received result value with the session ID, the prompt transmitted to the conversational AI server, and the ID of the user and the electronic pen that has sent the code information on which the prompt is based on, so as to generate session information. In addition, the first server stores this. The first server stores these pieces of information in the form of a JSON file, and may further store time information for the session ID in addition thereto.

In step 412, the second server extracts at least one piece of session information stored based on the user ID or the electronic pen ID for a pre-determined period, and transmits pre-determined session prompt information and the extracted at least one piece of session information to the conversational AI server.

A pre-determined session prompt may include the details related to a summary of at least one piece of session information. In addition, a pre-determined session prompt may include the details related to analysis of at least one piece of session information.

In step 413, the conversational AI server uses the language processing model with the session prompt received from the second server as an input value and generates a result value.

In step 414, the conversational AI server transmits the generated result value to the second server.

The second server stores the result value for the received session prompt. The second server provides at least one piece of session information and a result value for a session prompt to the user upon the user's request.

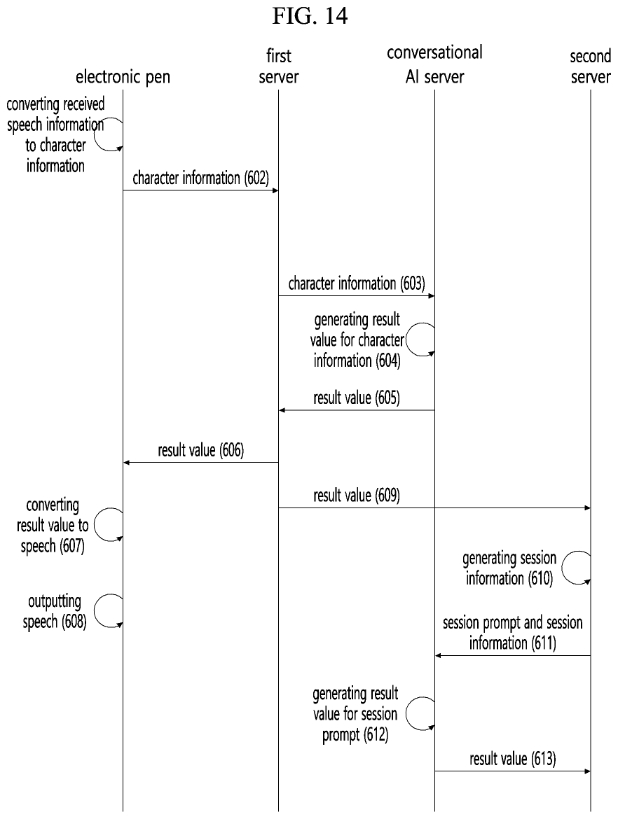

FIG. 14 is a flowchart illustrating a method of assisting a user to use a medium by using artificial context information according to a fourth embodiment. Hereinafter, as described above with reference to FIG. 7, the electronic device 1000 is named as the electronic pen 110, the main server 2000 is named as the first server 120, and the AI server 3000 is named as the conversational AI server 130. The details described with reference to FIG. 7 may be applied in the same way to each element.

In step 601, the electronic pen receives a speech input of the user through the microphone, and converts speech information to character information.

In step 602, the electronic pen transmits the character information resulting from conversion to the first server.

The first server associates and stores the received character information, ID information of the electronic pen user, and ID information of the electronic pen.

In step 603, the first server transmits the character information to the conversational AI server.

The conversational AI server is a server in which a language processing model for using AI is embedded, and means a server for providing a conversational AI service. Examples of the conversational AI service include ChatGPT of OpenAI, Bard or Gemini of Google, and Copilot of Microsoft.

In step 604, the conversational AI server uses the language processing model with the character information received from the first server as an input value and generates and extracts a result value.

The result value consists of string data.

In step 605, the conversational AI server transmits the extracted result value to the first server.

In step 606, the first server transmits the received result value to the electronic pen.

In step 607, the electronic pen uses a function of converting text to speech to convert the received result value to speech.

In step 608, the electronic pen outputs the speech resulting from conversion to the user of the electronic pen.

In step 609, the first server transmits the received result value to the second server.

In step 610, the second server generates session information.

A session means a series of processes of transmitting character information or a prompt to the conversational AI server and receiving a result value therefor. When one session is terminated, the first server associates a received result value with the session ID, the character information transmitted to the conversational AI server, and the ID of the user and the electronic pen that has transmitted the speech information on which the character information is based on, so as to generate session information. In addition, the second server stores this. The second server stores these pieces of information in the form of a JSON file, and may further store time information for the session ID in addition thereto.

In step 611, the second server extracts at least one piece of session information stored based on the user ID or the electronic pen ID for a pre-determined period, and transmits pre-determined session prompt information and the extracted at least one piece of session information to the conversational AI server.

A pre-determined session prompt may include the details related to a summary of at least one piece of session information. In addition, a pre-determined session prompt may include the details related to analysis of at least one piece of session information.

In step 612, the conversational AI server uses the language processing model with the session prompt received from the second server as an input value and generates a result value.

In step 613, the conversational AI server transmits the generated result value to the second server.

The second server stores the result value for the received session prompt. The second server provides at least one piece of session information and a result value for a session prompt to the user upon the user's request.

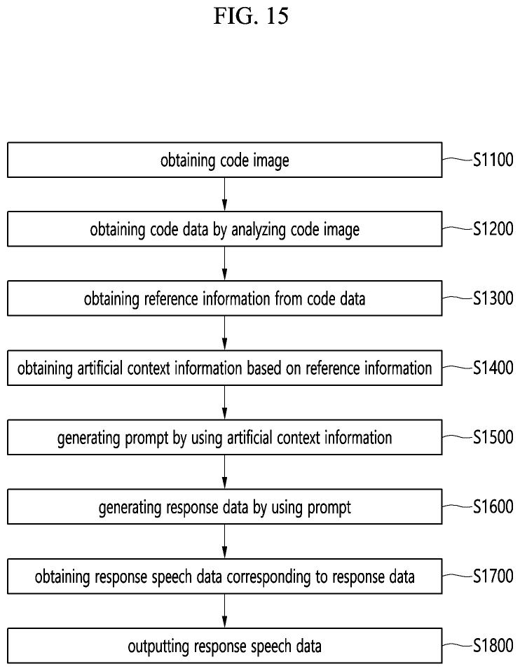

FIG. 15 is a flowchart illustrating a method of assisting a user to use a medium by using artificial context information, according to a fifth embodiment.

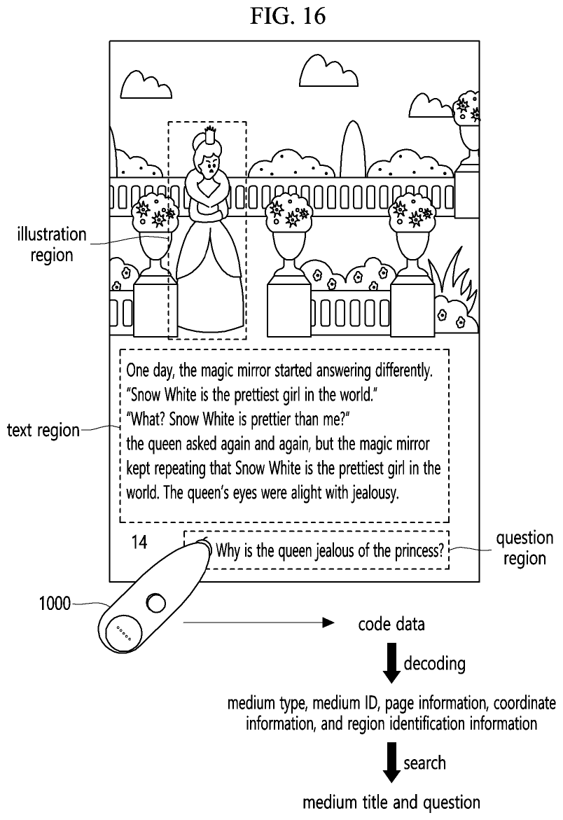

FIG. 16 is a diagram illustrating a process of obtaining artificial context information, according to the fifth embodiment.

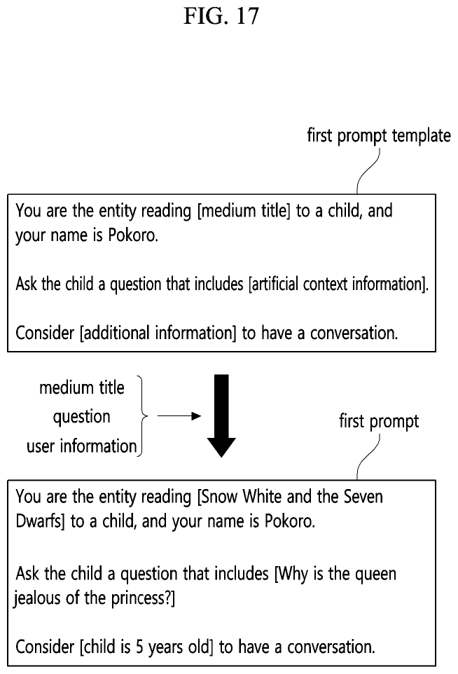

FIG. 17 is a diagram illustrating a prompt generated using artificial context information, according to the fifth embodiment.

Referring to FIG. 15, a method of assisting in the use of a medium may include obtaining a code image in step S1100, analyzing the code image to obtain code data in step S1200, obtaining reference information from the code data in step S1300, obtaining artificial context information based on the reference information in step S1400, using the artificial context information to generate a prompt in step S1500, using the prompt to generate response data in step S1600, obtaining response speech data corresponding to the response data in step S1700, and outputting the response speech data in step S1800.

Hereinafter, each step will be described in detail.

A code image may be obtained in step S1100. Specifically, a code is printed together with a content (text or illustration) on the medium, and when the user positions the electronic device 1000 in contact with or near a region of interest of the medium, the electronic device 1000 may use the sensing unit 1100 to capture at least part of the region of interest and obtain a code image. Herein, the sensing unit 1100 may be periodically activated to obtain an image. Alternatively, the sensing unit 1100 may be activated and an image may be obtained only when the user manipulates the button of the electronic device 1000.

Referring to FIG. 16, for example, the user may use the electronic device 1000 to touch a partial region of a question region (or the part of the question region having a figure) on page 14 of the book, and the electronic device 1000 may use the sensing unit 1100 to obtain the code image of the code printed in the touched region.

The code image may be analyzed to obtain code data in step S1200. Specifically, the electronic device 1000 or the main server 2000 may analyze the code image to obtain the code data. For example, the electronic device 1000 may transmit the code image to the main server 2000, and the main server 2000 may obtain the code data based on the arrangement of a plurality of fine points included in the code image. For another example, the electronic device 1000 may obtain code data from the code image, and transmit the obtained code data to the main server 2000. Herein, the code data may mean data in which particular information among pieces of information on the medium is encoded.

Reference information may be obtained from the code data in step S1300. Specifically, referring to FIG. 16, the main server 2000 may decode the code data to obtain at least one selected from the group of a medium type, a medium ID, page information, and position information (coordinate information and/or region identification information). For example, reference information obtained in FIG. 16 may include {book(medium type), BOOK000 (medium ID), 14(page information), A1(region identification information)}.

Based on the reference information, artificial context information may be obtained in step S1400. Specifically, referring to FIG. 16, the main server 2000 may search the database 2150 for information corresponding to the reference information among pieces of information on the medium to obtain a medium title and a question. As described above, a question is information that is less relevant to the flow of the story printed on the medium, and may be understood as artificial context information because the information is added by the content creator to increase the user's understanding about or interest in the story. For example, in FIG. 16, the obtained medium title is “Snow White and the Seven Dwarfs”, and the question is “Why is the queen jealous of the princess?”.

The artificial context information may be used to generate a prompt in step S1500. Specifically, the main server 2000 may use at least artificial context information to generate a prompt. For example, the main server 2000 may load a prompt template from the database 2150, and may modify the prompt template using the artificial context information to generate a prompt. The main server 2000 may load the prompt template corresponding to the reference information or the context information from the database 2150. In the meantime, in modifying the prompt template, the main server 2000 may use other pieces of information, such as context information or user information, other than artificial context information.

For example, referring to FIG. 17, the main server 2000 may load a first prompt template from the database 2150. The first prompt template is text including parts into which a medium title, artificial context information, and additional information are inserted. The main server 2000 may modify the first prompt template using the pre-obtained medium title “Snow White and the Seven Dwarfs” and question “Why is the queen jealous of the princess?”, and pre-stored user information “the child is 5 years old” (other user information, such as the user's sex, personality, or family relationship, may be used). The main server 2000 may modify the first prompt template to generate a first prompt.

As another example, the main server 2000 may modify the artificial context information or add details to generate a prompt. As still another example, the main server 2000 may generate a prompt including only the artificial context information.

The prompt may include an explanatory text that explains the artificial context information. In addition, the prompt may further include a guide text that describes considerations for the AI server 3000 to take into account when generating a response.

The prompt may be used to generate response data in step S1600. Specifically, the main server 2000 may transmit the prompt generated in step S1500 to the AI server 3000, and the AI server 3000 may input the received prompt to the large language model to generate the response data. For example, the AI server 3000 may receive the first prompt shown in FIG. 17 and generate response data, such as “Why is the queen jealous of the princess?”, or “I think the queen is jealous of Snow White. Why is the queen jealous of the princess?”.

The response data may be understood as data generated considering the artificial context information by the AI server 2000. That is, when the user uses the medium, the interactive system 100 may lead the user to converse, and the topic of the conversation may be related to the artificial context information.

The response data may be text data or speech data. Specifically, the large language model included in the AI server 3000 may be realized based on text or speech. When an input prompt is in the form of text, the large language model may output response data in the form of text. When an input prompt is in the form of a speech signal, the large language model may output speech response data.

Response speech data corresponding to the response data may be obtained in step S1700. Specifically, the main server 2000 may receive the response data from the AI server 3000, and may use the TTS model 2130 to convert the response data to response speech data. In the meantime, the main server 2000 may not include the TTS model 2130. In this case, the main server 2000 may use an external text-speech convert service to obtain response speech data corresponding to the response data. In addition, when the main server 2000 receives speech response data from the AI server 3000, the main server 2000 may use the data as it is without conversion.

The response speech data may be output in step S1800. Specifically, the main server 2000 may transmit the speech response data to the electronic device 1000, and the electronic device 1000 may output the speech response data through the electronic device output unit 1400.

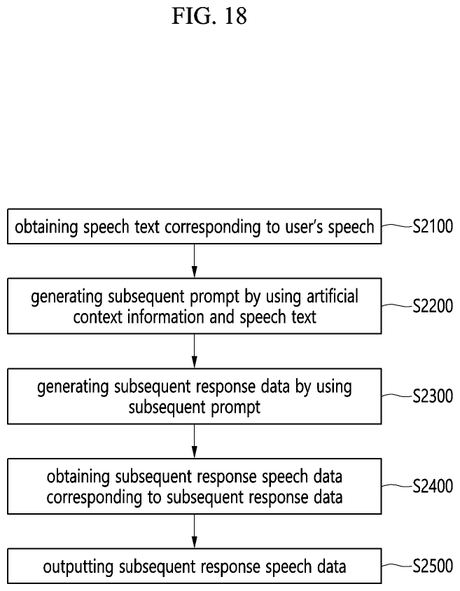

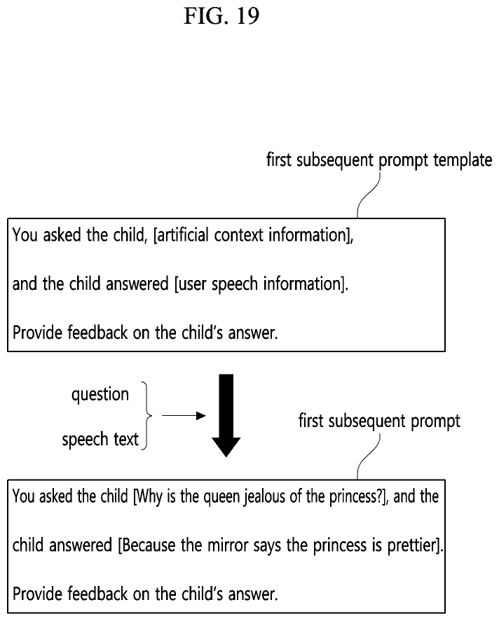

Hereinafter, a method of generating a subsequent prompt will be described with reference to FIGS. 18 and 19. The subsequent prompt may be generated when the response data generated previously considering the artificial context information is transferred to the user and the user responds to this. The main server 2000 generates and transmits the subsequent prompt to the AI server 3000, and the AI server 3000 outputs subsequent response data for the subsequent prompt, and the subsequent response data is transferred to the user, whereby a subsequent conversation may ensue.

FIG. 18 is a flowchart illustrating a method of generating a subsequent prompt, according to the fifth embodiment.

FIG. 19 is a diagram illustrating a subsequent prompt generated using artificial context information, according to the fifth embodiment.

Referring to FIG. 18, a method of generating a subsequent prompt may include obtaining speech text corresponding to the user's speech in step S2100, using the artificial context information and the speech text to generate the subsequent prompt in step S2200, using the subsequent prompt to generate subsequent response data in step S2300, obtaining subsequent response speech data corresponding to the subsequent response data in step S2400, and outputting the subsequent response speech data in step S2500.

Hereinafter, each step will be described in detail.

Speech text corresponding to the user's speech may be obtained in step S2100. Specifically, the electronic device 1000 may activate the microphone of the electronic device input unit 1300 by the user manipulating the button to record the user's speech. The electronic device 1000 may transmit the recorded user speech data to the main server 2000, and the main server 2000 may use the STT model 2110 to convert the user speech data to speech text. In the meantime, the main server 2000 may not include the STT model 2110. In this case, the main server 2000 may use an external speech-text convert service to obtain speech text corresponding to the user speech data.

The artificial context information and the speech text may be used to generate the subsequent prompt in step S2200. Specifically, the main server 2000 may use at least the artificial context information and the speech text to generate the subsequent prompt.

For example, the main server 2000 may load a subsequent prompt template from the database 2150, and may modify the subsequent prompt template using the artificial context information and the speech text to generate a prompt. Herein, the main server 2000 may load the subsequent prompt template corresponding to the reference information or the context information from the database 2150. In the meantime, in modifying the subsequent prompt template, the main server 2000 may use other pieces of information, such as context information or user information, other than artificial context information.

For example, referring to FIG. 19, the main server 2000 may load a first subsequent prompt template from the database 2150. The first subsequent prompt template may be text including parts into which the artificial context information and user speech information are inserted. The main server 2000 may modify the first subsequent prompt template using the question “Why is the queen jealous of the princess?” obtained in step S1400 and the speech text “Because the mirror says the princess is prettier” obtained in step S2100 described above. The main server 2000 may modify the first subsequent prompt template to generate a first subsequent prompt.

As another example, the main server 2000 may modify the speech text or add details to generate a subsequent prompt. As still another example, the main server 2000 may generate a subsequent prompt including only the speech text.

The subsequent prompt may include an explanatory text that explains the speech text. In addition, the subsequent prompt may further include a guide text that describes considerations for the AI server 3000 to take into account when generating a response.

The subsequent prompt may be used to generate subsequent response data in step S2300. Specifically, the main server 2000 may transmit the subsequent prompt generated in step S2200 to the AI server 3000, and the AI server 3000 may input the received subsequent prompt to the large language model to generate the subsequent response data. For example, the AI server 3000 may receive the first subsequent prompt shown in FIG. 19 and generate subsequent response data, such as “That's right, the queen is jealous of the princess because of the mirror”, or “That's right, the queen is jealous of the princess because of the mirror, have you ever felt jealous of someone?”.

The subsequent response data may be understood as data generated considering the artificial context information by the AI server 2000. That is, after the interactive system 100 leads the user to converse, the topic of the conversation may be continuously related to the artificial context information.

The subsequent response data may be text data or speech data. Specifically, the large language model included in the AI server 3000 may be realized based on text or speech. When an input subsequent prompt is in the form of text, the large language model may output subsequent response data in the form of text. When an input subsequent prompt is in the form of a speech signal, the large language model may output subsequent speech response data.

Subsequent response speech data corresponding to the subsequent response data may be obtained in step S2400. Specifically, the main server 2000 may receive the subsequent response data from the AI server 3000, and may use the TTS model 2130 to convert the subsequent response data to subsequent response speech data. In the meantime, the main server 2000 may not include the TTS model 2130. In this case, the main server 2000 may use an external text-speech convert service to obtain subsequent response speech data corresponding to the subsequent response data. In addition, when the main server 2000 receives subsequent speech response data from the AI server 3000, the main server 2000 may use the data as it is without conversion.

The subsequent response speech data may be output in step S2500. Specifically, the main server 2000 may transmit the subsequent speech response data to the electronic device 1000, and the electronic device 1000 may output the subsequent speech response data through the electronic device output unit 1400.

After the subsequent response speech data is output, the method of generating a subsequent prompt may be performed again. Specifically, when the user records his or her speech using the electronic device 1000, the obtained speech text and the artificial context information may be used to generate a subsequent prompt, and subsequent speech response data for the subsequent prompt may be generated and output to the user (herein, the subsequent prompt template may vary). This means that the conversation between the interactive system 100 and the user continues.

In the meantime, when the artificial context information in use varies (e.g., when the user touches or points at another question region with the electronic device 1000 and another piece of artificial context information is thus obtained), the session may be terminated and a new session may start. Herein, a session means a conversation about one piece of artificial context information. Starting a new session means that the method of assisting the user to use the medium by using the artificial context information shown in FIG. 15 is performed again.

The main server 2000 may store the prompt and the response data generated in a session as session information. The session information may be used to generate analysis information as described above. For example, the main server 2000 or the AI server 3000 may use the session information to generate at least one selected from the group of a conversation log indicating a conversation between the user and the electronic device 1000, a conversation summary summarizing a conversation between the user and the electronic device 1000, a pronunciation evaluation indicating an evaluation of the user's pronunciation, a keyword that the user frequently uses, the user's medium use time, the user's medium type-specific use time, and the user's interest field.

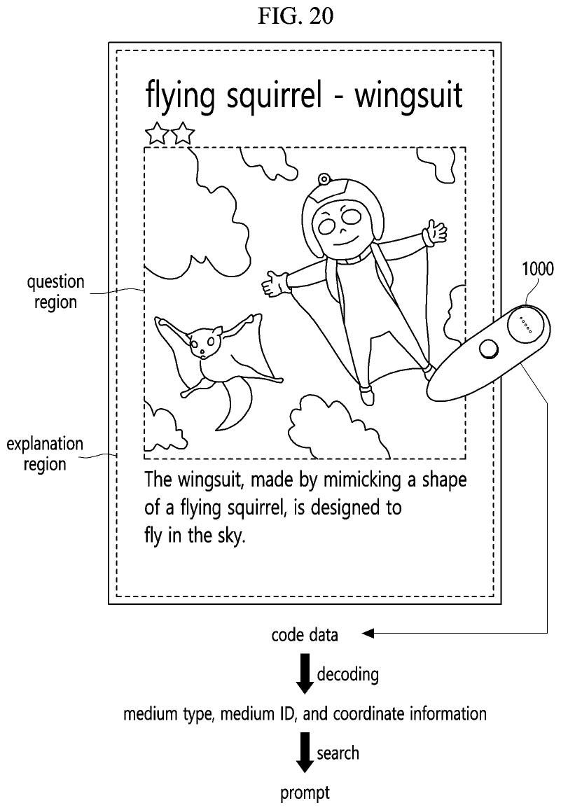

Hereinafter, in the method in which the interactive system 100 uses the artificial context information to assist the user to use the medium, a method of assisting the user to use the medium by using a pre-stored prompt will be described with reference to FIGS. 20 to 22.

FIG. 20 is a diagram illustrating a process of obtaining a pre-stored prompt, according to a sixth embodiment.

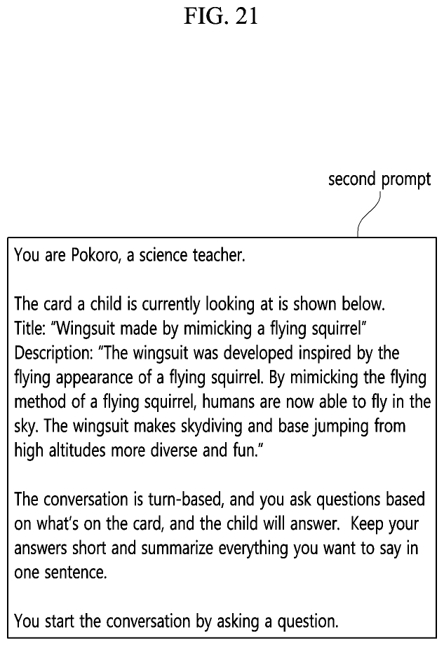

FIG. 21 is a diagram illustrating a pre-stored prompt, according to the sixth embodiment.

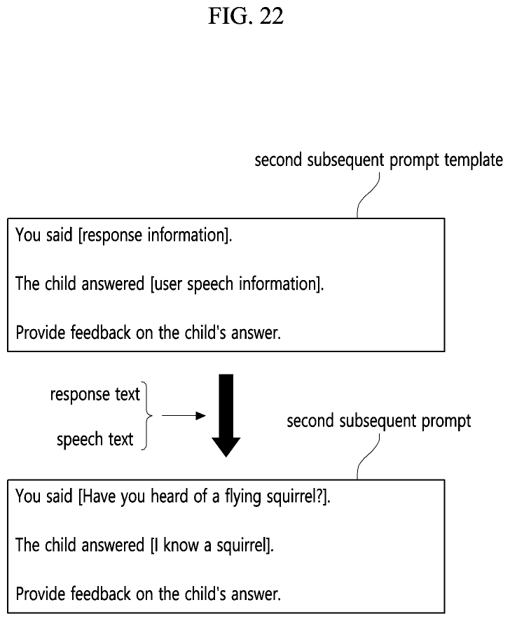

FIG. 22 is a diagram illustrating a subsequent prompt generated using artificial context information, according to the sixth embodiment.

The method of assisting the user to use the medium by using the pre-stored prompt may include the steps described in FIGS. 15 and 18. Therefore, the parts duplicating the above-described details will be omitted, and the details described with reference to FIGS. 15 and 18 may be applied in the same way.

Referring to FIG. 20, a medium is a card on which particular information is printed, and the user may position the electronic device 1000 in contact with or at a region of the card. In the medium, a question region and an explanation region may be distinguished from each other.

When the electronic device 1000 is in contact with or is positioned at a region of the card, reference information may be obtained as described in steps S1100 to S1300. Herein, the reference information may include a medium type, a medium ID, and position information (coordinate information and/or region identification information). For example, referring to FIG. 20, the reference information may be {card(medium type), CARD000(medium ID), (1308.59, 393.417)(coordinate information)}.

The main server 2000 may load a prompt corresponding to the reference information from the database 2150. The prompt may be pre-stored in the database 2150, and may be input to the large language model of the AI server 3000 without additional modification or processing.

In the meantime, position information of the reference information may vary depending on the region with which the electronic device 1000 is in contact, and the prompt that is loaded may vary depending on whether the position information is included in the question region or the explanation region (when the position information is coordinate information) or whether the position information indicates the question region or the explanation region (when the position information is region identification information).

For example, when the position information is included in the question region or indicates the question region, the main server 2000 may load a second prompt shown in FIG. 21. The second prompt may include information on a content printed on the card, and a guide for generating a question to start a conversation. The main server 2000 may transmit the second prompt to the AI server 3000, and the AI server 3000 may use the second prompt to generate response data. The response data may be, for example, “Have you heard of a flying squirrel?”.

Afterward, speech corresponding to the response data may be output to the user according to steps S1700 and S1800.

After the speech corresponding to the response data is output to the user, the user may activate the recording function of the electronic device 1000 to answer to the output speech so that user speech data may be obtained. Afterward, step S2100 may be performed to obtain speech text.

The main server 2000 may use a response text and speech text to generate a subsequent prompt. Herein, the response text means the response data generated using the pre-stored prompt described above.

For example, referring to FIG. 22, the main server 2000 may load a second subsequent prompt template from the database 2150. The second subsequent prompt template may be text including parts into which the response information and user speech information are inserted. The main server 2000 may modify the second subsequent prompt template using the response text “Have you heard of a flying squirrel?” and the speech text “I know a squirrel” obtained previously. The main server 2000 may modify the second subsequent prompt template to generate a second subsequent prompt.

As another example, the main server 2000 may modify the speech text or add details to generate a subsequent prompt. As still another example, the main server 2000 may generate a subsequent prompt including only the speech text.

The subsequent prompt may include an explanatory text that explains the speech text. In addition, the prompt may further include a guide text that describes considerations for the AI server 3000 to take into account when generating a response.

Afterward, steps S2300 to S2500 may be performed and subsequent response speech data corresponding to the subsequent prompt may be output to the user.

After the subsequent response speech data is output, the method of generating a subsequent prompt may be performed again. Specifically, when the user further records his or her speech using the electronic device 1000, the obtained speech text may be used to generate a subsequent prompt, and subsequent speech response data for the subsequent prompt may be generated and output to the user. This means that the conversation between the interactive system 100 and the user continues. Herein, the subsequent prompt template may vary.

In the meantime, when the medium ID is changed (e.g., when the user touches another card with the electronic device 1000), the session may be terminated and a new session may start. Herein, a session means a conversation conducted for one medium. Starting a new session means that the method of assisting the user to use the medium by using the pre-stored prompt described above is performed again.

The main server 2000 may store the prompt and the response data generated in a session as session information. The session information may be used to generate analysis information as described above. For example, the main server 2000 or the AI server 3000 may use the session information to generate at least one selected from the group of a conversation log indicating a conversation between the user and the electronic device 1000, a conversation summary summarizing a conversation between the user and the electronic device 1000, a pronunciation evaluation indicating an evaluation of the user's pronunciation, a keyword that the user frequently uses, the user's medium use time, the user's medium type-specific use time, and the user's interest field.

### 5. Interaction Using Medium Context Information

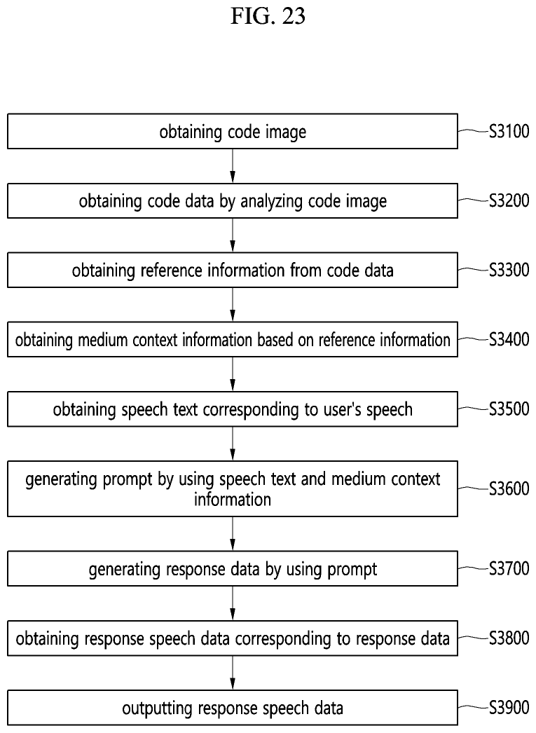

Hereinafter, a method in which the interactive system 100 uses medium context information to assist a user to use a medium will be described with reference to FIGS. 23 to 27.

The user (especially, a child) may talk about things that he or she is curious or thoughts that come to mind while reading the book. In this case, the user's speech may be input to the large language model and response data may be provided. However, herein, the questions or thoughts that the user expresses come while reading the book. In order to generate more appropriate response data, the large language model needs to understand the context in which the user is speaking, such as the intent or purpose of what the user is saying.

As a method for the large language model to understand the context of the user, content information printed on the medium may be provided to the large language model. More specifically, the user's speech and information on the title or details of the book the user is reading or the details in which the user is interested are input together to the large language model, response data to be output may be expected to be generated within the context of the user.

FIG. 23 is a flowchart illustrating a method of assisting a user to use a medium by using medium context information, according to a seventh embodiment.

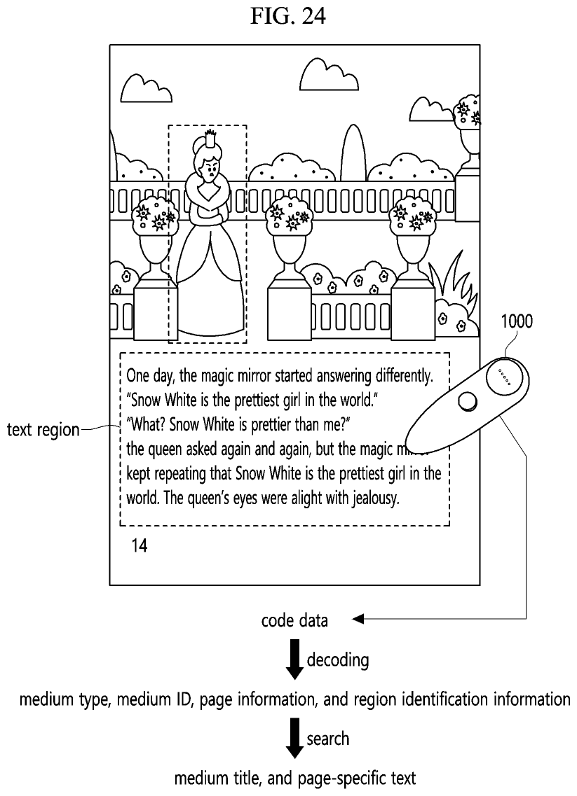

FIG. 24 is a diagram illustrating a process of obtaining medium context information, according to the seventh embodiment.

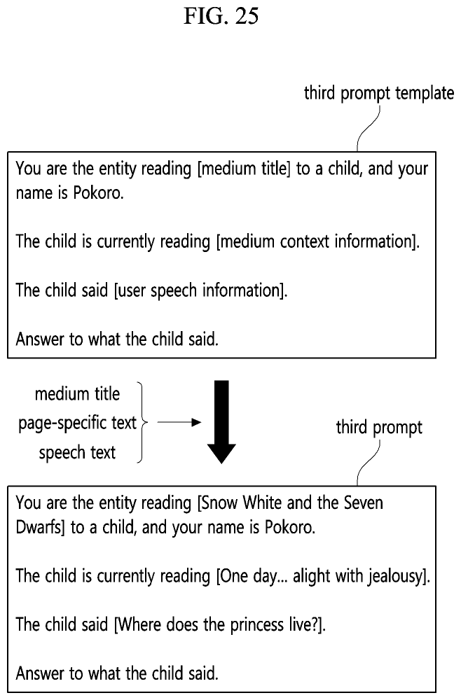

FIG. 25 is a diagram illustrating a prompt generated using medium context information, according to the seventh embodiment.

Referring to FIG. 23, a method of assisting in the use of a medium may include obtaining a code image in step S3100, analyzing the code image to obtain code data in step S3200, obtaining reference information from the code data in step S3300, obtaining medium context information based on the reference information in step S3400, obtaining speech text corresponding to the user's speech in step S3500, using the speech text and the medium context information to generate a prompt in step S3600, using the prompt to generate response data in step S3700, obtaining response speech data corresponding to the response data in step S3800, and outputting the response speech data in step S3900.

Hereinafter, each step will be described in detail. However, step S3100 is the same as step S1100, step S3200 is the same as step S1200, step S3800 is the same as step S1700, and step S3900 is the same as step S1800, so the details described with reference to FIG. 15 may be applied in the same way.

After steps S3100 and S3200 are performed, reference information may be obtained from the code data in step S3300. Herein, the code image obtained in step S3100 may be obtained by the user touching a text region in which text is printed on a particular page of the medium with the electronic device 1000.

Referring to FIG. 24, the main server 2000 may decode the code data to obtain at least one selected from the group of a medium type, a medium ID, page information, and position information (coordinate information and/or region identification information). For example, reference information obtained by the main server 2000 in FIG. 24 may include {book(medium type), BOOK 000(medium ID), 14(page information), A2(region identification information) }.

Based on the reference information, medium context information may be obtained in step S3400. Specifically, referring to FIG. 24, the main server 2000 may search the database 2150 for information corresponding to the reference information among pieces of information on the medium to obtain a medium title and a page-specific text. As described above, the page-specific text is information on the flow of the story printed on the medium, and may be understood as medium context information. For example, the medium title obtained in FIG. 24 is “Snow White and the Seven Dwarfs”, and a page-specific text is “One day, the magic mirror started answering differently. ”Snow White is the prettiest girl in the world.“ ”What? she's prettier than me?“ the queen asked again and again, but the magic mirror kept repeating that Snow White was the prettiest girl in the world. The queen's eyes were alight with jealousy.” (hereinafter, referred to as “One day . . . alight with jealousy”).

In the meantime, the medium context information has been described as a page-specific text, but the technical idea of the present disclosure is not limited thereto. The medium context information may be the entire text or illustration printed on the medium, or a part thereof the user is interested in. That is, the medium context information may include text related to a part of the medium touched by the user with the electronic device 1000 or text of a summary or variation thereof. The medium context information may be a word, sentence, or paragraph, and the medium context information may include an illustration.

Speech text corresponding to the user's speech may be obtained in step S3500. Specifically, the electronic device 1000 may activate the microphone of the electronic device input unit 1300 by the user manipulating the button to record the user's speech. The electronic device 1000 may transmit the recorded user speech data to the main server 2000, and the main server 2000 may use the STT model 2110 to convert the user speech data to speech text. In the meantime, the main server 2000 may not include the STT model 2110. In this case, the main server 2000 may use an external speech-text convert service to obtain speech text corresponding to the user speech data.

A prompt may be generated using the speech text and the medium context information in step S3600. Specifically, the main server 2000 may use at least the speech text and the medium context information to generate a prompt. For example, the main server 2000 may load a prompt template from the database 2150, and may modify the prompt template using the speech text and the medium context information to generate a prompt.

The main server 2000 may load the prompt template corresponding to the reference information (e.g., a medium type, a medium ID, page information, and region identification information) or context information (e.g., a medium title) from the database 2150. In the meantime, in modifying the prompt template, the main server 2000 may use other pieces of information, such as context information or user information, other than medium context information.

For example, referring to FIG. 25, the main server 2000 may load a third prompt template from the database 2150. The third prompt template is text including parts into which a medium title, medium context information, and user speech information are inserted. The main server 2000 may modify the third prompt template using the pre-obtained medium title “Snow White and the Seven Dwarfs” and the page-specific text “One day . . . alight with jealousy”, and speech text “Where does the princess live?”. The main server 2000 may modify the third prompt template to generate a third prompt.

As another example, the main server 2000 may partially modify the medium context information and the speech text or add details to generate a prompt. As still another example, the main server 2000 may separately generate a prompt including only medium context information and a prompt including only speech text and transmit the prompts sequentially to the AI server 3000.

The prompt may include an explanatory text that explains the medium context information. In addition, the prompt may further include a guide text that describes considerations for the AI server 3000 to take into account when generating a response.

The prompt may be used to generate response data in step S3700. Specifically, the main server 2000 may transmit the prompt generated in step S3600 to the AI server 3000, and the AI server 3000 may input the received prompt to the large language model to generate the response data. For example, the AI server 3000 may receive the third prompt shown in FIG. 25 and generate response data, such as “The princess lives in a castle with the queen”, or “The princess lives in a castle with the queen, what else do you want to know?”.

The response data may be understood as data generated considering the medium context information by the AI server 2000. That is, when the user uses the medium, the interactive system 100 may lead the user to converse, and the topic of the conversation may be related to the part of the story the user is reading (or interested in) that is printed on the medium.

The response data may be text data or speech data. Specifically, the large language model included in the AI server 3000 may be realized based on text or speech. When an input prompt is in the form of text, the large language model may output response data in the form of text. When an input prompt is in the form of a speech signal, the large language model may output speech response data.

Afterward, steps S3800 and S3900 are performed and response speech data corresponding to the response data may be output to the user.

After the speech corresponding to the response data is output to the user, the user may activate the recording function of the electronic device 1000 to answer to the output speech so that user speech data may be obtained.

In this case, the main server 2000 generates and transmits the subsequent prompt to the AI server 3000, and the AI server 3000 outputs subsequent response data for the subsequent prompt, and the subsequent response data is transferred to the user, whereby a subsequent conversation may ensue.

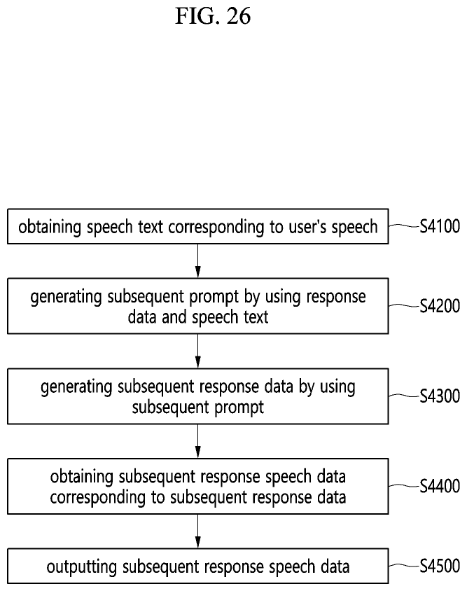

Hereinafter, a method of generating a subsequent prompt will be described with reference to FIG. 26.

FIG. 26 is a flowchart illustrating a method of generating a subsequent prompt, according to the seventh embodiment.

Referring to FIG. 26, a method of generating a subsequent prompt may include obtaining speech text corresponding to the user's speech in step S4100, using the medium context information and the speech text to generate a subsequent prompt in step S4200, using the subsequent prompt to generate subsequent response data in step S4300, obtaining subsequent response speech data corresponding to the subsequent response data in step S4400, and outputting the subsequent response speech data in step S4500.

Herein, step S4100 is the same as step S2100, step S4300 is the same as step S2300, step S4400 is the same as step S2400, step S4500 is the same as step S2500, so the details described with reference to FIG. 18 may be applied in the same way.

Therefore, only step S4200 will be described in detail.

After step S4100 is performed to obtain speech text, the response data and the speech text may be used to generate the subsequent prompt in step S4200. Specifically, the main server 2000 may use at least the response data and the speech text to generate the subsequent prompt. Herein, the response data means the data generated in step S3700.

For example, the main server 2000 may load a subsequent prompt template from the database 2150, and may modify the subsequent prompt template using the response data and the speech text to generate a prompt. Herein, the main server 2000 may load the subsequent prompt template corresponding to the reference information or the context information from the database 2150. In the meantime, in modifying the subsequent prompt template, the main server 2000 may use other pieces of information, such as medium context information or user information, other than the response data and the speech text.

For another example, the main server 2000 may generate a subsequent prompt including response data and speech text obtained previously. Herein, the response data and the speech data may each be partially modified or details may be added.

For still another example, the main server 2000 may modify the speech text or add details to generate a subsequent prompt. As still another example, the main server 2000 may generate a subsequent prompt including only the speech text.

Afterward, steps S4300 to S4500 are performed and subsequent response speech data may be output to the user through the electronic device 1000.

### 6. Interaction Using Artificial Context Information and Medium Context Information

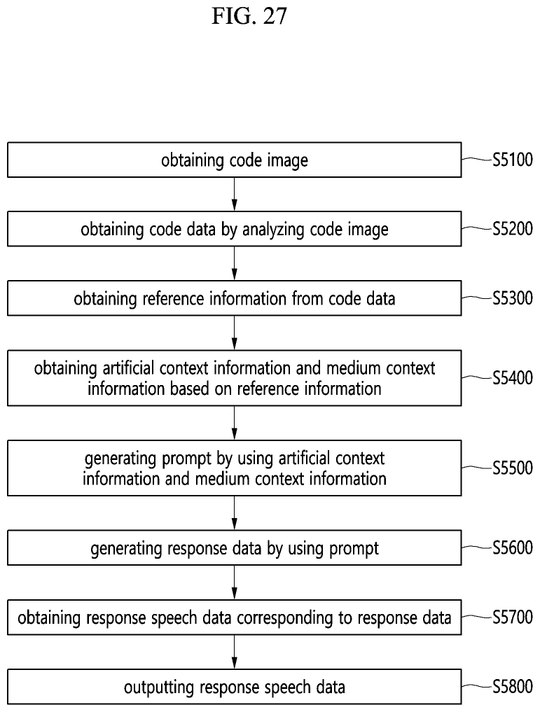

Hereinafter, a method in which the interactive system 100 uses artificial context information and medium context information to assist a user to use a medium will be described with reference to FIGS. 27 to 29.

FIG. 27 is a flowchart illustrating a method of assisting a user to use a medium by using artificial context information and medium context information, according to an eighth embodiment.

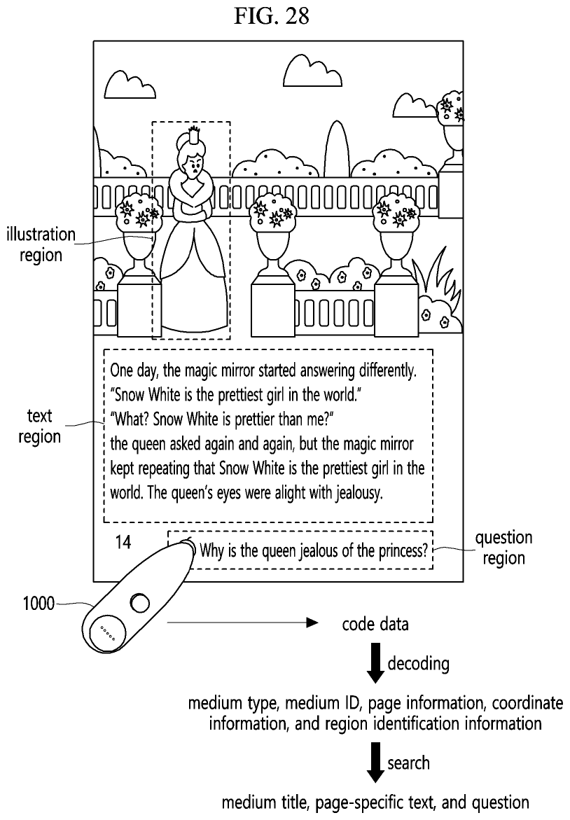

FIG. 28 is a diagram illustrating a process of obtaining artificial context information and medium context information, according to the eighth embodiment.

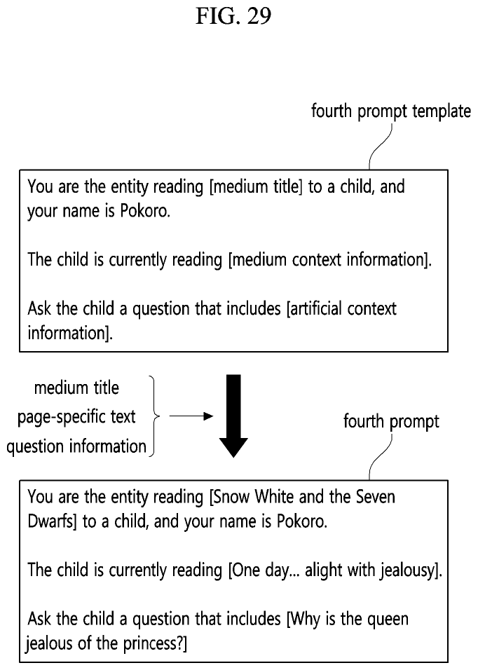

FIG. 29 is a diagram illustrating a prompt generate d using artificial context information and medium context information, according to the eighth embodiment.

Referring to FIG. 27, a method of assisting in the use of a medium may include obtaining a code image in step S5100, analyzing the code image to obtain code data in step S5200, obtaining reference information from the code data in step S5300, obtaining artificial context information and medium context information based on the reference information in step S5400, using the artificial context information and the medium context information to generate a prompt in step S5500, using the prompt to generate response data in step S5600, obtaining response speech data corresponding to the response data in step S5700, and outputting the response speech data in step S5800.

Hereinafter, each step will be described in detail. However, step S5100 is the same as step S1100, step S5200 is the same as step S1200, step S5700 is the same as step S1700, and step S5800 is the same as step S1800, so the details described with reference to FIG. 15 may be applied in the same way.

After steps S5100 and S5200 are performed, reference information may be obtained from the code data in step S5300. Herein, the code image obtained in step S5100 may be obtained by the user touching a question region on a particular page of the medium with the electronic device 1000.

Referring to FIG. 28, the main server 2000 may decode the code data to obtain at least one selected from the group of a medium type, a medium ID, page information, and position information (coordinate information and/or region identification information). For example, reference information obtained by the main server 2000 in FIG. 28 may include {book(medium type), BOOK 000(medium ID), 14(page information), A1(region identification information)}.

Based on the reference information, artificial context information and medium context information may be obtained in step S5400. Specifically, referring to FIG. 28, the main server 2000 may search the database 2150 for information corresponding to the reference information among pieces of information on the medium to obtain a medium title, a page-specific text, and a question. As described above, the page-specific text is information on the flow of the story printed on the medium, and may be understood as medium context information. As described above, a question is less relevant to the flow of the story printed on the medium, and may be understood as artificial context information because the question is created by the content creator to increase the user's interest and understanding.

For example, in FIG. 28, the obtained medium title is “Snow White and the Seven Dwarfs”, the page-specific text is “One day . . . alight with jealousy”, and the question is “Why is the queen jealous of the princess?”. In the meantime, the medium context information has been described as a page-specific text, but the technical idea of the present disclosure is not limited thereto. The medium context information may be a page-specific text as well as text or illustration information printed throughout the medium. Alternatively, the medium context information may be a particular sentence within a particular page. In addition, although the artificial context information has been described as a question, the technical idea of the present disclosure is not limited thereto. The details that help understanding of the medium without affecting the flow of the story, such as indicating specific learning, may be obtained as artificial context information.

The artificial context information and the medium context information may be used to generate a prompt in step S5500. Specifically, the main server 2000 may use at least the artificial context information and the medium context information to generate a prompt. For example, the main server 2000 may load a prompt template from the database 2150, and may modify the prompt template using the artificial context information and the medium context information to generate a prompt.

The main server 2000 may load the prompt template corresponding to the reference information (e.g., a medium type, a medium ID, page information, and region identification information) or context information (e.g., a medium title) from the database 2150. In the meantime, in modifying the prompt template, the main server 2000 may further use other pieces of information, such as context information or user information, other than the artificial context information and the medium context information.

For example, referring to FIG. 29, the main server 2000 may load a fourth prompt template from the database 2150. The fourth prompt template is text including parts into which a medium title, medium context information, and artificial context information are inserted. The main server 2000 may modify the fourth prompt template using the pre-obtained medium title “Snow White and the Seven Dwarfs” and the page-specific text “One day . . . alight with jealousy”, and question information “Why is the queen jealous of the princess?”. The main server 2000 may modify the fourth prompt template to generate a fourth prompt.

As another example, the main server 2000 may partially modify the artificial context information and the medium context information or add details to generate a prompt. As another example, the main server 2000 may separately generate a prompt including only artificial context information or a prompt including only medium context information and transmit the prompts sequentially to the AI server 3000.

The prompt may include an explanatory text that explains the artificial context information. In addition, the prompt may further include a guide text that describes considerations for the AI server 3000 to take into account when generating a response.

The prompt may be used to generate response data in step S5600. Specifically, the main server 2000 may transmit the prompt generated in step S5500 to the AI server 3000, and the AI server 3000 may input the received prompt to the large language model to generate the response data. For example, the AI server 3000 may receive the fourth prompt shown in FIG. 29 and generate response data, such as “Why is the queen jealous of the princess?”, or “Why is the queen jealous of the princess? What did the mirror say?”.

The response data may be understood as data generated considering the artificial context information and the medium context information by the AI server 2000. That is, when the user uses the medium, the interactive system 100 may lead the user to converse, and the topic of the conversation may be related to the part of the story the user is reading (or interested in) that is printed on the medium, and the conversation may be understood as unfolding considering deep learning (to improve understanding of the medium) led by the content creator.

The response data may be text data or speech data. Specifically, the large language model included in the AI server 3000 may be realized based on text or speech. When an input prompt is in the form of text, the large language model may output response data in the form of text. When an input prompt is in the form of a speech signal, the large language model may output speech response data.

Afterward, steps S5700 and S5800 are performed and response speech data corresponding to the response data may be output to the user.

After the speech corresponding to the response data is output to the user, the user may activate the recording function of the electronic device 1000 to answer to the output speech so that user speech data may be obtained.

In this case, the method of generating a subsequent prompt described with reference to FIG. 18 may be performed, and subsequent response data corresponding to the subsequent prompt may be generated, and the subsequent response data is thus transferred to the user, whereby a subsequent conversation may ensue. In generating a subsequent prompt, herein, it is to be understood that artificial context information as well as medium context information may be used.

### 7. Generative Model Processes Various Types of Data

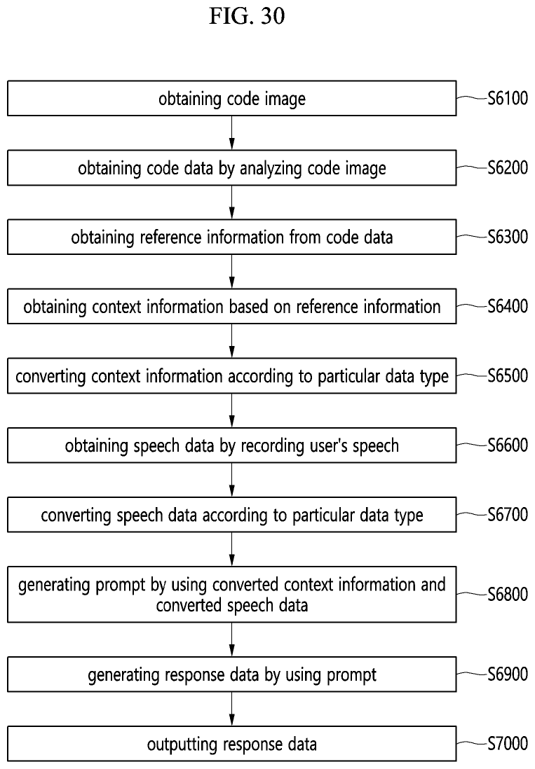

Hereinafter, a method of assisting a user to use a medium by using context information when a generative model stored in the AI server 3000 processes data in a form other than text data will be described with reference to FIG. 30.

FIG. 30 is a flowchart illustrating a method of assisting a user to use a medium by using context information according to a ninth embodiment.

Referring to FIG. 30, a method of assisting in the use of a medium may include obtaining a code image in step S6100, analyzing the code image to obtain code data in step S6200, obtaining reference information from the code data in step S6300, obtaining context information based on the reference information in step S6400, converting the context information according to a particular data type in step S6500, obtaining speech data by recording the user's speech in step S6600, converting the speech data according to a particular data type in step S6700, using the context information resulting from conversion and the speech data resulting from conversion to generate a prompt in step S6800, using the prompt to generate response data in step S6900, and outputting the response data in step S7000.

Hereinafter, each step will be described in detail. However, step S6100 is the same as step S1100, and step S6200 is the same as step S1200, so the details described with reference to FIG. 15 may be applied in the same way.

After steps S6100 and S6200 are performed, reference information may be obtained from the code data in step S6300. Herein, the code image obtained in step S6100 may be obtained by the user touching a region (e.g., a text region, an illustration region, or a question region) on a particular page of the medium with the electronic device 1000.

The reference information may include at least one selected from the group of a medium type, a medium ID, page information, and position information (coordinate information and/or region identification information).

Based on the reference information, context information may be obtained in step S6400. Herein, the context information may include artificial context information and/or medium context information. As an example of a method of obtaining artificial context information, the method described in step S1400 may be applied in the same way. As an example of a method of obtaining medium context information, the method described in step S3400 may be applied in the same way. As a method of obtaining artificial context information and medium context information, the method described in step S5500 may be applied in the same way.

In the meantime, context information may include at least one selected from the group of text, a sound, an image, or a video. For example, the context information may include text printed on a particular page of the medium, speech reading a printed text, a sound related to a printed text, an image of a printed text, or a video related to a printed text. For another example, the context information may include an image printed on a particular page of the medium, text describing a printed image, speech describing a printed image, a sound related to a printed image, or a video related to a printed image.

The context information may be converted according to a particular data type in step S6500. For example, the main server 2000 may convert the context information based on a data type that the generative model stored in the AI server 3000 is able to process. Herein, a data type that the generative model is able to process means a data type of input data the generative model supports (or a data type that is input to output an appropriate response), and may include at least one selected from the group of text, a sound, an image, or a video.

For example, when the context information includes text and the data type that the generative model may receive as an input is sound, the main server 2000 may convert the text of the context information into a sound (e.g., speech). Herein, the above-described TTS model 2130 may be used or an external server that may perform a function of converting text to speech may be used.

As another example, when the context information includes an image or video and the data type that the generative model may receive as an input is text, the main server 2000 may convert the image or video of the context information to text. Herein, the text means an explanation of the image or an explanation of the video.

In the meantime, the generative model may process a plurality of data types, and the data type of the context information is included in the data types that the generative model may process, the main server 2000 may not convert the context information. For example, when the context information includes a sound and the data types that the generative model may receive as inputs are text and sound, the main server 2000 may not convert the context information. That is, step S6500 may be omitted.

The main server 2000 may obtain speech data by recording the user's speech in step S6600. Specifically, the electronic device 1000 may activate the microphone of the electronic device input unit 1300 by the user manipulating the button to record the user's speech. The electronic device 1000 may transmit the recorded user speech data to the main server 2000. Herein, the speech data may be understood as data having speech information or a speech signal.

The speech data may be converted according to a particular data type in step S6700. For example, the main server 2000 may convert the speech data based on a data type the generative model stored in the AI server 3000 is able to process. Herein, a data type that the generative model is able to process means a data type of input data the generative model supports (or a data type that is input to output an appropriate response), and may include at least one selected from the group of text, a sound, an image, or a video.

For example, when the data type that the generative model may receive as an input is text, the main server 2000 may convert speech data to text. Herein, the above-described STT model 2110 may be used or an external server that may perform a function of converting speech to text may be used.

In the meantime, the data types that the generative model may receive as inputs may include sound. Herein, the main server 2000 may not convert speech data. That is, step S6700 may be omitted.

The context information resulting from conversion and the speech data resulting from conversion may be used to generate a prompt in step S6800. Specifically, the main server 2000 may generate a prompt using the context information resulting from conversion obtained in step S6500 and the speech data resulting from conversion obtained in step S6700.

For example, the main server 2000 may generate a prompt by concatenating the context information resulting from conversion and the speech data resulting from conversion.

As another example, the main server 2000 may use the above-described prompt template, but may process the prompt template using the context information resulting from conversion and the speech data resulting from conversion and generate a prompt.

In the meantime, the data type of the context information resulting from conversion and the data type of the speech data resulting from conversion may be the same or different from each other. The main server 2000 may generate a prompt after unifying the data type of the context information resulting from conversion and the data type of the speech data resulting from conversion into any one.

The prompt may be used to generate response data in step S6900. For example, the main server 2000 may transmit the generated prompt to the AI server 3000, and the AI server 300 may use the generative model to generate response data from the prompt.

The data type of the generated response data may include at least one selected from the group of text, a sound, an image, and a video. The data type of the response data may vary depending on the process in which the generative model is trained. The generative model may be trained to receive data including at least one data type selected from the group of text, a sound, an image, and a video, and output data including at least one data type selected from the group of text, a sound, an image, and a video.

The response data may be output to the user in step S7000. Specifically, the main server 2000 may transfer the response data to the electronic device 1000 with or without conversion. Herein, the form in which the response data is output by the electronic device 1000 may vary depending on the data type of the response data.

For example, when the response data is text, the main server 2000 may convert the response data to response speech data and provide the response speech data to the electronic device 1000, and the electronic device 1000 may output the response speech data through the speaker of the electronic device output unit 1400. Herein, the TTS model 2130 of the main server 2000 may be used.

As another example, when the response data is speech (or sound), the main server 2000 may provide the response data to the electronic device 1000 without conversion, and the electronic device 1000 may output the response data through the speaker of the electronic device output unit 1400.

As another example, when the response data is an image or video, the main server 2000 may convert the response data to response speech data and provide the response speech data to the electronic device 1000, and the electronic device 1000 may output the response data through the speaker of the electronic device output unit 1400.

As another example, when the response data is an image or video, the main server 2000 may provide the response data as it is to the electronic device 1000 without conversion, and the electronic device 1000 may output the response data through the display of the electronic device output unit 1400.

As the generative model stored in the AI server 3000 is able to process various types of data, the response data output to the user may be understood to be generated considering the context of the user more. For example, when the user asks a question while pointing to an image within the medium with the electronic device 1000, a process of converting the image to text needs to be followed if the generative model is able to process only text. The text resulting from conversion is related to the image, but is not the image itself. Therefore, the response data that may be generated by the generative model cannot be considered to have been generated with a clear understanding of the user's interest or question intent. However, when the generative model is able to process both text and an image, the generative model may receive an original image and generate response data with a clearer understanding of the user's interest or question intent.

Accordingly, a response more appropriate to the user, that is, a response more suitable for the purpose of the question of the user may be provided.

The features, structures and effects described in the embodiments are included in at least one embodiment of the present specification, and are not necessarily limited to one embodiment. Furthermore, the features, structures, and effects provided in each embodiment can be combined or modified in other embodiments by those skilled in the art to which the embodiments pertains. Therefore, contents related to the combination and modification should be construed to be included in the scope of the present specification.

Further, the above description has been made mainly based on the embodiments, which are merely illustrative and do not limit the technical idea of the present specification. Various modifications and changes may be made by those skilled in the art without departing from the essential characteristics of the present specification. That is, each component specifically shown in the embodiments may be modified. Further, differences related to such modifications and applications should be construed as being included in the scope of the present specification as defined in the appended claims.

What is claimed is:

1. A server for communicating with an electronic device and an AI(Artificial Intelligence) server, the server comprising:
a memory,
a communication unit; and
a control unit configured to control the memory and the communication unit;
wherein the control unit is configured to:
[1] obtain reference information encoded in code data obtained by the electronic device,
wherein the reference information is received via the communication unit from the electronic device or is obtained by the controller decoding the code data after receiving the code data via the communication unit from the electronic device,
wherein the reference information is related to a medium that a user interacts with by using the electronic device, and
wherein the reference information includes medium ID information of the medium, page information indicated by the electronic device, and position information within a page indicated by the electronic device;
[2] based on the reference information, obtain from the memory interest content related to printed content in the medium and/or a part that the user is interested in among the printed content in the medium and generate medium context information;
[3] obtain a speech text corresponding to a speech of the user obtained by the electronic device,
wherein the speech text is obtained by converting the speech with STT(Speech-To-Text) conversion;
[4] generate a prompt based on the obtained medium context information and the speech text,
wherein the prompt includes the medium context information and the speech text;
[5] transmit the prompt to the AI server via the communication unit;
[6] receive, via the communication unit, a response of the AI server for the transmitted prompt;
[7] obtain a response speech corresponding to the received response; and
[8] transmit the response speech to the electronic device via the communication unit.

2. The server of claim 1,
wherein the memory stores a plurality of medium texts and each of the medium texts corresponds to at least part of a particular medium, and
wherein the control unit loads a medium text corresponding to the medium ID information of the reference information among the plurality of medium texts from the memory and obtains the medium text as the medium context information.

3. The server of claim 1,
wherein the memory stores a plurality of page-specific texts and each of the page-specific texts corresponds to at least part of texts printed on a particular page of a particular medium, and
wherein the control unit loads a page-specific text corresponding to the medium ID information and the page information of the reference information among the plurality of page-specific texts from the memory and obtains the page-specific text as the medium context information.

4. The server of claim 1,
wherein the memory stores a plurality of position-specific texts and each of the position-specific texts corresponds to at least part of texts printed on a particular position in a particular page of a particular medium, and
wherein the control unit loads a position-specific text corresponding to the medium ID information, the page information, and the position information of the reference information among the plurality of position-specific texts from the memory and obtains the position-specific text as the medium context information.

5. The server of claim 1,
wherein the prompt is generated by concatenating the speech text to the medium context information.

6. The server of claim 1,
wherein the prompt further includes an explanatory text for the medium context information.

7. The server of claim 1,
wherein the prompt further includes pre-stored user information, and
wherein the user information includes at least one of an age and sex for the user.

8. The server of claim 1,
wherein the prompt further includes a pre-stored guide text, and
wherein the guide text includes a consideration for the AI server when generating the response.

9. The server of claim 1,
wherein the control unit:
obtains a prompt template, and
modifies the prompt template using the medium context information and the speech text to generate the prompt.

10. The server of claim 1,
wherein the prompt includes at least part of a past prompt transmitted to the AI server before the code data is obtained from the electronic device.

11. The server of claim 10,
wherein the control unit transmits the past prompt to the AI server via the communication unit and receives a past response for the past prompt from the AI server, and
wherein the prompt includes at least part of the past response.

12. The server of claim 1,
wherein the reference information further includes region identification information related to a question or an instruction printed in the medium with which the user is interacting using the electronic device, and the region identification information identifies a preset region in the medium,
wherein the control unit, based on the reference information, obtains artificial context information corresponding to the question or the instruction printed on the preset region from the memory, and
wherein the prompt further includes the artificial context information.

13. The server of claim 1,
wherein the control unit:
obtains a subsequent speech text corresponding to a subsequent speech of the user obtained by the electronic device, wherein the subsequent speech is obtained by converting the subsequent speech with STT conversion,
generates a subsequent prompt based on the subsequent speech text,
transmits the subsequent prompt to the AI server via the communication unit,
receives a subsequent response of the AI server the transmitted subsequent prompt via the communication unit,
obtains a subsequent response speech corresponding to the subsequent response, and
transmits the subsequent response speech to the electronic device via the communication unit.

14. The server of claim 13,
wherein the subsequent prompt further includes the medium context information.

15. The server of claim 1,
wherein the AI server comprises LLM(Large Language Model).

16. The server of claim 1,
wherein the electronic device:
comprises an image sensor, and
is configured to capture a region of the medium by the user's manipulation and obtain the code data from a captured image.

17. The server of claim 1,
wherein the electronic device has a pen-shape with one end and other end, and
wherein in response to the user indicating a region of the medium with the one end of the electronic device, the electronic device is configured to capture the medium by using an image sensor arranged at the one end.

18. A server for communicating with an electronic device and an AI(Artificial Intelligence) server, the server comprising:
a memory;
a communication unit; and
a control unit configured to control the memory and the communication unit;
wherein the control unit is configured to:
[1] obtain reference information encoded in code data obtained by the electronic device,
wherein the reference information is received via the communication unit from the electronic device or is obtained by the controller decoding the code data after receiving the code data via the communication unit from the electronic device,
wherein the reference information is related to a medium that a user interacts with by using the electronic device, and
wherein the reference information includes medium ID information of the medium, page information indicated by the electronic device, and position information within a page indicated by the electronic device;
[2] based on the reference information, obtain from the memory interest content related to printed content in the medium and/or a part that the user is interested in among the printed content in the medium and generate medium context information;
[3] obtain speech data corresponding to a speech of the user obtained by the electronic device,
[4] generate a prompt based on the obtained medium context information and the speech data,
[5] transmit the prompt to the AI server via the communication unit;
[6] receive, via the communication unit, a response of the AI server for the transmitted prompt; and
[7] transmit the received response or a response speech corresponding to the response to the electronic device via the communication unit.

19. The server of claim 18,
wherein a data type of the medium context information is any one of text, sound, image or video.

20. The server of claim 18,
wherein, when a data type of the medium context information is text and a data type supported by the AI server is sound, the control unit convert the medium context information such that the data
type of the medium context information becomes sound, before generating the prompt.
